(19) United States
(12) Patent Application Publication
(10) Pub. No.: US 2026/0214624 A1
(43) Pub. Date: Jul. 23, 2026

(54) MULTI-HYPOTHESIS MEASUREMENT REPORTING FROM THE USER EQUIPMENT (UE) TO THE LOCATION SERVER

(71) Applicant: QUALCOMM Incorporated, San Diego, CA (US)

(72) Inventors: Khurram Usman MAZHER, San Diego, CA (US); Alexandros MANOLAKOS, Athens (GR); Varun Amar REDDY, San Diego, CA (US); Marko ANGJELICHINOSKI, San Diego, CA (US); Krishna Kiran MUKKAVILLI, San Diego, CA (US)

(21) Appl. No.: 19/144,200

(22) PCT Filed: Feb. 1, 2024
(86) PCT No.: PCT/US2024/013965

§ 371 Date: Jun. 27, 2025

(30) Foreign Application Priority Data
Feb. 17, 2023 (GR) 20230100138

(51) Int. Cl. H04W 64/00; H04W 24/08; H04W 24/10; H04W 72/0446; H04W 72/0453

(52) U.S. Cl. CPC H04W 64/00; H04W 24/08; H04W 24/10; H04W 72/0446; H04W 72/0453

(57) ABSTRACT

Disclosed are techniques for wireless communication. In an aspect, a user equipment (UE) receives, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal, and obtains the one or more positioning measurements of the downlink signal for each of the one or more TRPs using the one or more hypotheses.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes receiving, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal; and obtaining the one or more positioning measurements of the downlink signal for each of the one or more TRPs using the one or more hypotheses.

In an aspect, a method of communication performed by a server includes receiving, from a first user equipment (UE), identifiers of one or more transmission-reception points (TRPs) observed by the first UE; and transmitting, to the first UE, a request to obtain one or more positioning measurements according to one or more hypotheses for measuring a downlink signal transmitted by the one or more TRPs, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal.

In an aspect, a user equipment (UE) includes a memory; at least one transceiver; and at least one processor communicatively coupled to the memory and the at least one transceiver, the at least one processor configured to: receive, via the at least one transceiver, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal; and obtain the one or more positioning measurements of the downlink signal for each of the one or more TRPs using the one or more hypotheses.

In an aspect, a server includes a memory; at least one transceiver; and at least one processor communicatively coupled to the memory and the at least one transceiver, the at least one processor configured to: receive, via the at least one transceiver, from a first user equipment (UE), identifiers of one or more transmission-reception points (TRPs) observed by the first UE; and transmit, via the at least one transceiver, to the first UE, a request to obtain one or more positioning measurements according to one or more hypotheses for measuring a downlink signal transmitted by the one or more TRPs, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal.

In an aspect, a user equipment (UE) includes means for receiving, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal; and means for obtaining the one or more positioning measurements of the downlink signal for each of the one or more TRPs using the one or more hypotheses.

In an aspect, a server includes means for receiving, from a first user equipment (UE), identifiers of one or more transmission-reception points (TRPs) observed by the first UE; and means for transmitting, to the first UE, a request to obtain one or more positioning measurements according to one or more hypotheses for measuring a downlink signal transmitted by the one or more TRPs, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal.

In an aspect, a non-transitory computer-readable medium storing computer-executable instructions that, when executed by a user equipment (UE), cause the UE to: receive, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal; and obtain the one or more positioning measurements of the downlink signal for each of the one or more TRPs using the one or more hypotheses.

In an aspect, a non-transitory computer-readable medium storing computer-executable instructions that, when executed by a server, cause the server to: receive, from a first user equipment (UE), identifiers of one or more transmission-reception points (TRPs) observed by the first UE; and transmit, to the first UE, a request to obtain one or more positioning measurements according to one or more hypotheses for measuring a downlink signal transmitted by the one or more TRPs, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates a time difference of arrival (TDOA)-based positioning procedure in an example wireless communications system, according to aspects of the disclosure.

FIG. 5 is a diagram illustrating an example frame structure, according to aspects of the disclosure.

FIG. 6 is a diagram illustrating an example tracking reference signal (TRS) configuration, according to aspects of the disclosure.

FIG. 7 is a graph of an example channel energy response (CER) estimate, according to aspects of the disclosure.

FIG. 8 illustrates an example CIE-based positioning procedure using TRS, according to aspects of the disclosure.

FIG. 9 illustrates an example multi-UE joint location estimation procedure, according to aspects of the disclosure.

FIGS. 10 and 11 are diagrams illustrating example hypotheses in which time-of-arrival (ToA) estimation is based on a sliding window of channel measurements, according to aspects of the disclosure.

FIG. 12 illustrates a method for calculating the position of a UE based on multiple hypotheses, according to aspects of the disclosure.

FIG. 13 illustrates an example multi-UE joint location estimation procedure using transmission-reception point (TRP)-specific hypotheses, according to aspects of the disclosure.

FIG. 14 illustrates an example multi-UE joint location estimation procedure using network operator-specific hypotheses, according to aspects of the disclosure.

FIG. 15 illustrates an example multi-UE joint location estimation procedure using TRP-specific hypotheses for UE-based positioning, according to aspects of the disclosure.

FIG. 16 is a graph of a cumulative distribution function (CDF) of absolute downlink time of arrival (DL-TOA) errors of example New Radio (NR) links, according to aspects of the disclosure.

FIGS. 17 and 18 illustrate example methods of communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to over-the-top (OTT) positioning. Some aspects more specifically relate to obtaining and reporting positioning measurements of OTT cellular signals (e.g., tracking reference signals (TRS)) using multiple hypotheses. In some examples, a UE can track multiple coherency hypotheses for a positioning measurement (e.g., time of arrival (ToA)) based on various levels of integration and report them back to an OTT server (e.g., a connected intelligent edge (CIE) server). On the server side, the server can determine which hypothesis resulted in more outliers or better performance in terms of signal strength measurements. More specifically, the UE reports each hypothesis and the positioning measurement(s) obtained using that hypothesis. For each hypothesis, the server uses the measurements obtained with that hypothesis for pruning and outlier rejection. The server can then determine which hypothesis is best (e.g., results in the highest signal strength, most accurate ToA estimate, etc.) for the UE.

Particular aspects of the subject matter described in this disclosure can be implemented to realize one or more of the following potential advantages. In some examples, by determining and using the best coherency hypothesis for measuring OTT signals, the described techniques can be used to improve OTT positioning performance for the UE.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

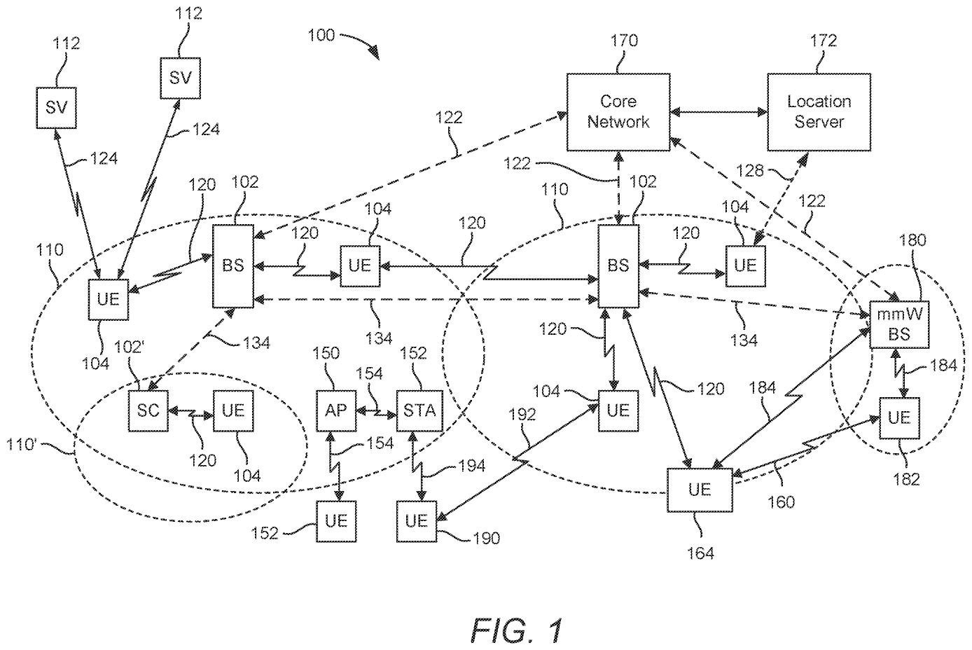

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some time and/or frequency resources, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage arca 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of time/frequency resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. I only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

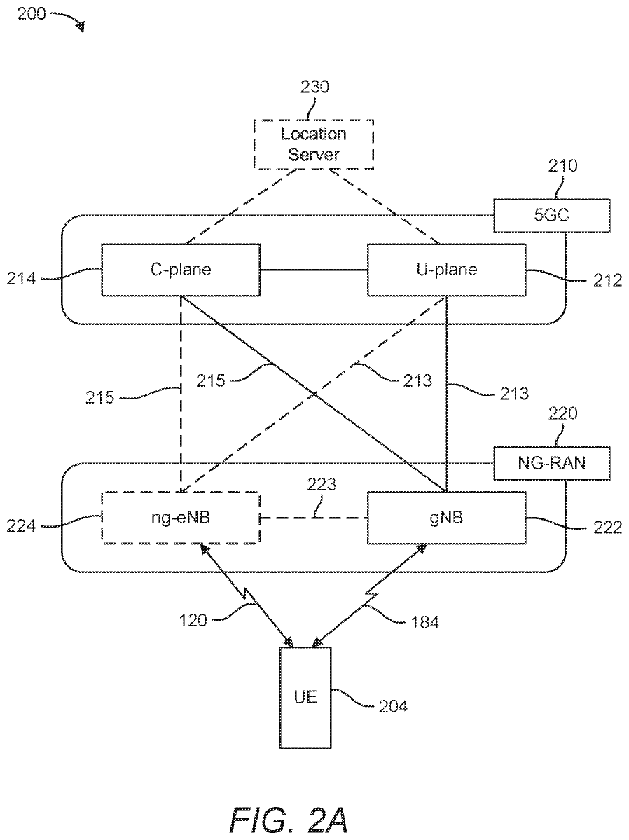

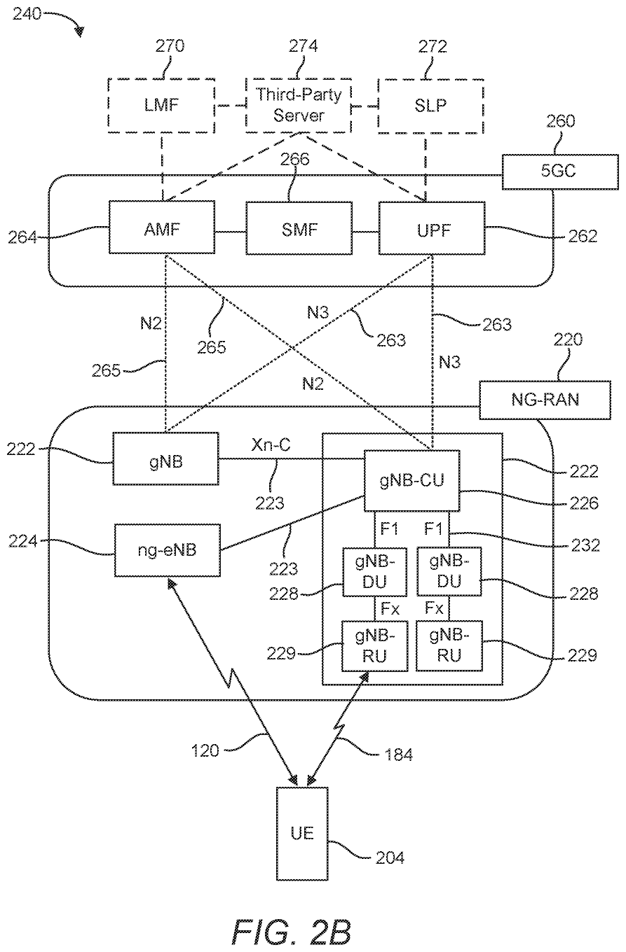

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

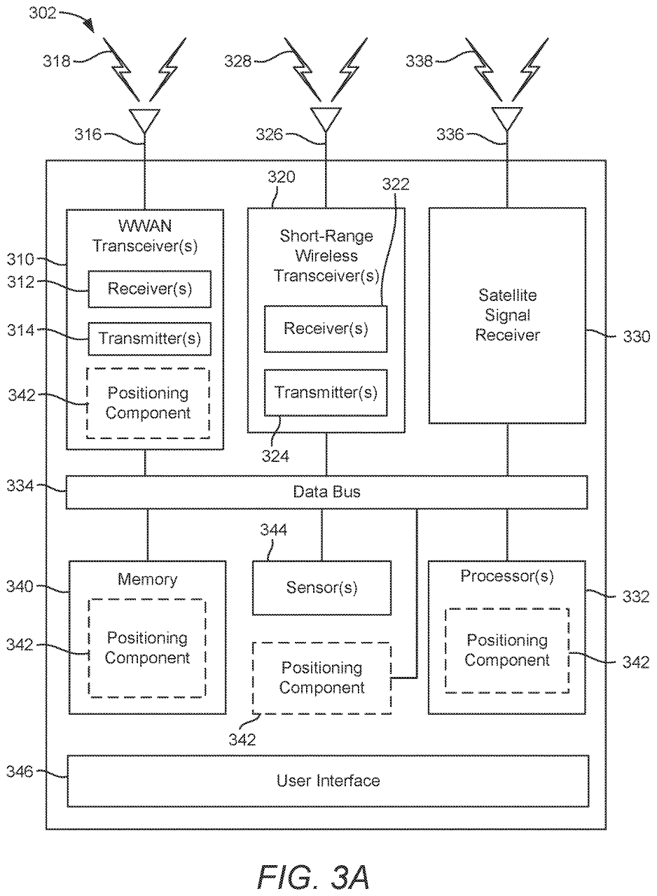

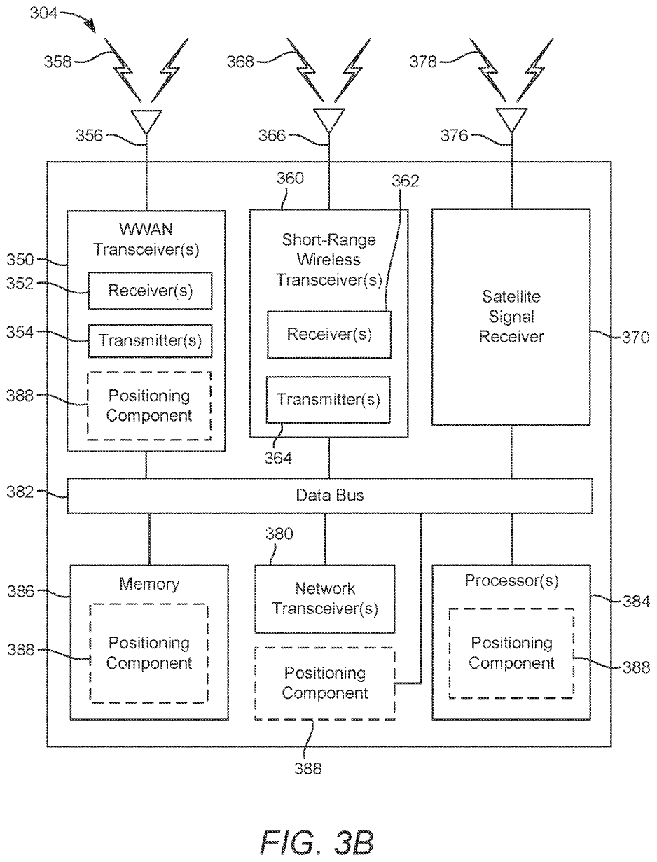

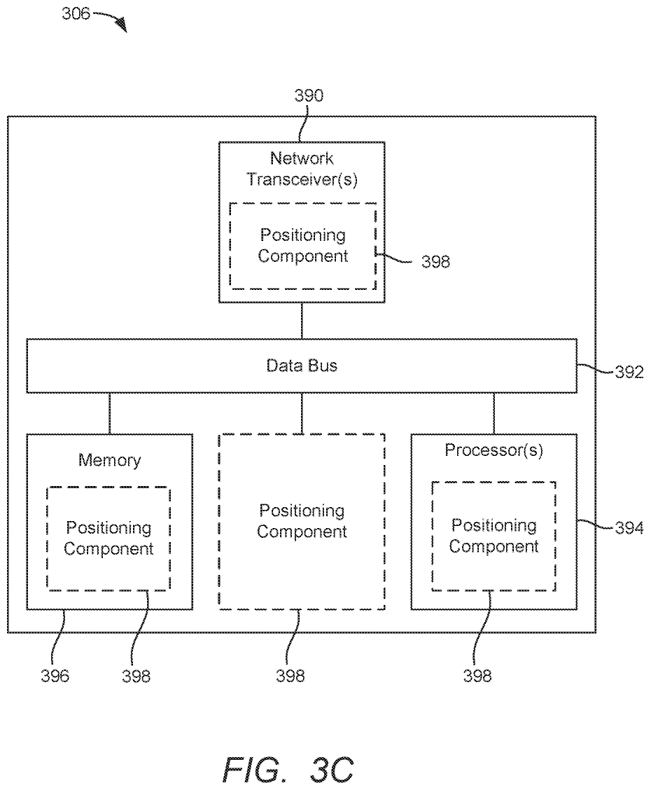

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

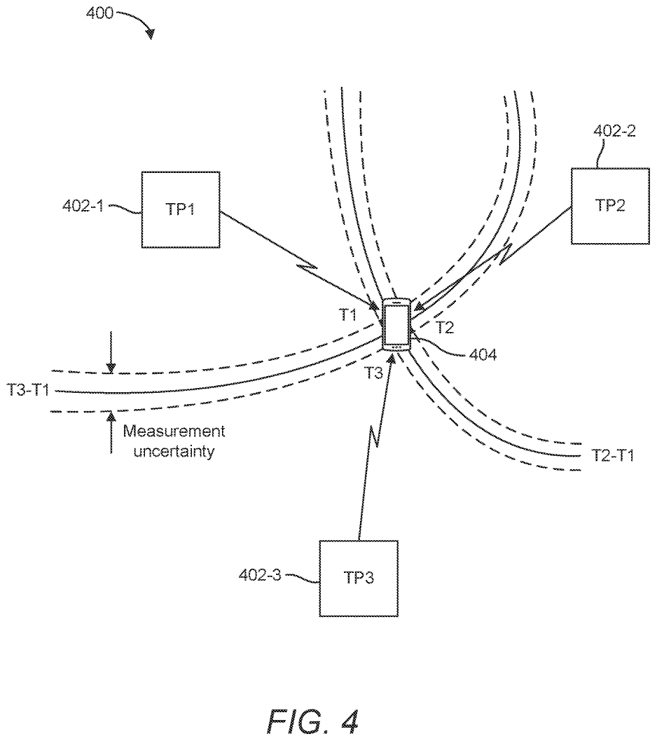

FIG. 4 illustrates a time difference of arrival (TDOA)-based positioning procedure in an example wireless communications system 400, according to aspects of the disclosure. The TDOA-based positioning procedure may be an observed time difference of arrival (OTDOA) positioning procedure, as in LTE, or a downlink time difference of arrival (DL-TDOA) positioning procedure, as in 5G NR. In the example of FIG. 4, a UE 404 (e.g., any of the UEs described herein) is attempting to calculate an estimate of its location (referred to as “UE-based” positioning), or assist another entity (e.g., a base station or core network component, another UE, a location server, a third party application, etc.) to calculate an estimate of its location (referred to as “UE-assisted” positioning). The UE 404 may communicate with (e.g., send information to and receive information from) one or more of a plurality of transmission points 402 (e.g., any combination of base stations, TRPs, SVs, etc. described herein), labeled “TP1” 402-1, “TP2” 402-2, and “TP3” 402-3.

To support location estimates, the transmission points 402 may be configured to broadcast positioning signals (e.g., positioning reference signals (PRS), tracking reference signals (TRS), cell-specific reference signals (CRS), channel state information reference signals (CSI-RS), demodulation reference signals (DMRS), etc.) to a UE 404 in their coverage areas to enable the UE 404 to measure characteristics of such reference signals. In a TDOA-based positioning procedure, the UE 404 measures the relative time difference, known as the reference signal time difference (RSTD) or TDOA, between a reference transmission point 402 and each of two or more non-reference transmission points 402. The UE 404 may determine the relative time difference as the difference between the start of a subframe (or slot) from a non-reference transmission point 402 and the start of a subframe (or slot) from the reference transmission point 402 that is closest in time to the subframe received from the reference transmission point 402.

More particularly, the RSTD for a non-reference transmission point “j” relative to a reference transmission point “i” may be given as T_SubframeRx,j−T_SubframeRx,i, where T_SubframeRx,j is the time when the UE 404 received the start of one subframe from transmission point j and T_SubframeRx,i is the time when the UE 404 received the corresponding start of one subframe from transmission point i that is closest in time to the subframe received from transmission point j. In the example of FIG. 4, the measured RSTDs between the transmission point 402-1 (the reference transmission point) and the transmission points 402-2 and 402-3 may be represented as T2−T1 and T3−T1, where T1, T2, and T3 represent the time when the UE 404 received the start of one subframe from the transmission point 402-1, 402-2, and 402-3, respectively. The UE 404 may determine the start of a subframe (or slot) based on measurements of one or more downlink reference signals (e.g., PRS, TRS, CRS, CSI-RS, etc.) transmitted by the respective transmission points 402.

For FR1, the reference point for the RSTD measurement is the antenna connector of the UE 404. For FR2, the reference point for the RSTD measurement is the antenna of the UE 404. The reference transmission point 402 remains the same for all RSTDs measured by the UE 404 for any single positioning use of TDOA and would typically correspond to the serving cell for the UE 404 or another nearby cell with good signal strength at the UE 404. In an aspect, the non-reference transmission points 402 would normally be cells supported by base stations different from the base station for the reference cell, and may have good or poor signal strength at the UE 404.

To assist TDOA-based positioning operations, a location server (e.g., location server 230, LMF 270, SLP 272) may provide assistance data to the UE 404 for the reference transmission point 402 and the non-reference transmission points 402 relative to the transmission point 402. For example, the assistance data may include identifiers (e.g., PCI, VCI, CGI, etc.) for each transmission point 402 of a set of transmission points 402 that the UE 404 is expected to measure. The assistance data may also provide the center channel frequency of each transmission point 402, various reference signal configuration parameters (e.g., the number of consecutive positioning slots, periodicity of positioning slots, muting sequence, frequency hopping sequence, reference signal identifier, reference signal bandwidth), and/or other transmission point-related parameters applicable to TDOA-based positioning procedures. The assistance data may also indicate the serving cell for the UE 404 as the reference transmission point 402.

In some cases, the assistance data may also include “expected RSTD” parameters, which provide the UE 404 with information about the RSTD values the UE 404 is expected to measure between the reference transmission point 402 and each non-reference transmission point 402 at its current location, together with an uncertainty of the expected RSTD parameter. The expected RSTD, together with the associated uncertainty, may define a search window for the UE 404 within which the UE 404 is expected to measure the RSTD value. In some cases, the value range of the expected RSTD may be +/−500 microseconds (μs). That is, the full reporting range of an RSTD measurement is [−0.5 ms, 0.5 ms]. In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

In an aspect, while the location server (e.g., location server 230, LMF 270, SLP 272) may send the assistance data to the UE 404, alternatively, the assistance data can originate directly from the transmission points 402 themselves (e.g., in periodically broadcasted overhead messages, etc.). Alternatively, the UE 404 can detect non-reference transmission points (e.g., neighbor cells) itself without the use of assistance data.

The UE 404 may either report the RSTD measurements to a location server (e.g., location server 230, LMF 270, SLP 272) or compute a location estimate itself from the RSTD measurements. Using (i) the RSTD measurements, (ii) the known absolute or relative transmission timing of each transmission point 402 (e.g., regarding whether the transmission points 402 are accurately synchronized or whether each transmission point 402 transmits with some known time offset relative to other transmission points 402), (iii) the known location(s) of the transmission points 402, and/or (iv) directional reference signal characteristics, such as the direction of transmission (if known), the UE's 404 location may be determined (either by the UE 404 or the location server).

In an aspect, the location estimate may specify the location of the UE 404 in a two-dimensional (2D) coordinate system; however, the aspects disclosed herein are not so limited, and may also be applicable to determining location estimates using a three-dimensional (3D) coordinate system, if the extra dimension is desired. Additionally, while FIG. 4 illustrates one UE 404 and three transmission points 402, as will be appreciated, there may be more UEs 404 and more transmission points 402.

Still referring to FIG. 4, when the UE 404 obtains a location estimate using RSTDs, the necessary additional data (e.g., the transmission points'402 locations and relative transmission timing) may be provided to the UE 404 by the location server. In some implementations, a location estimate for the UE 404 may be obtained (e.g., by the UE 404 itself or by the location server) from RSTDs and from other measurements made by the UE 404 (e.g., measurements of signal timing from global positioning system (GPS) or other global navigation satellite system (GNSS) satellites). In these implementations, known as hybrid positioning, the RSTD measurements may contribute towards obtaining the UE's 404 location estimate but may not wholly determine the location estimate.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

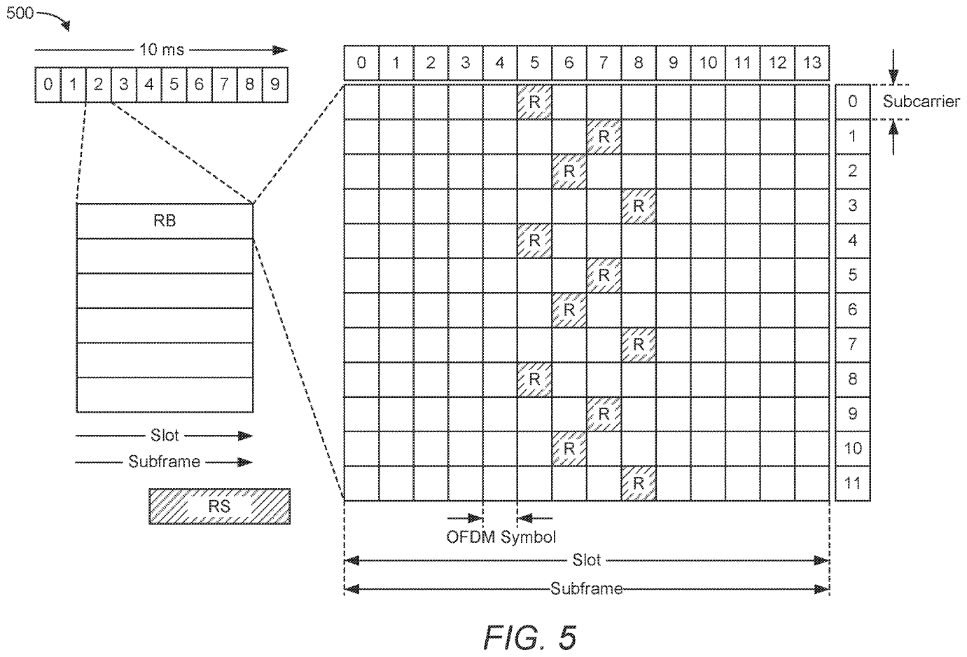

Various frame structures may be used to support downlink and uplink transmissions between network nodes (e.g., base stations and UEs). FIG. 5 is a diagram 500 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 5, a numerology of 15 kHz is used. Thus, in the time domain, a 10 ms frame is divided into 10 equally sized subframes of 1 ms each, and each subframe includes one time slot. In FIG. 5, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 5, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication, FIG. 5 illustrates example locations of REs carrying a reference signal (labeled “R”).

A new type of edge computing has been introduced, referred to as “intelligent edge,” “intelligence at the edge,” “connected intelligent edge” (CIE), and the like. CIE is a continually expanding set of connected systems and devices that gather and process data closer to where it is captured in a network. In this way, users can obtain real-time insights and experiences, delivered by highly responsive and contextually aware applications.

A CIE server (a third-party server external to an operator's cellular network) may perform positioning operations with one or more UEs, much like a location server (e.g., LMF 270), but without coordinating with a location server or any base stations to configure specific reference signal transmissions for the UE(s) to measure. Rather, the CIE server and UE(s) utilize reference signals already transmitted in cellular networks (e.g., 5G and/or LTE networks). This type of positioning, without coordination with a location server or base station, but rather, utilizing reference signals that are already scheduled to be transmitted to and measured by a connected UE, is referred to as “OTT positioning.” The reference signals measured by the UE are referred to as “OTT reference signals,” “OTT signals,” or the like.

For example, TRS may be used for positioning purposes, such as CIE-based positioning. TRS are configured in each cell with their own time, frequency, and scrambling identifier. It is mandatory for all UEs to support TRS reception, and all 5G networks are required to transmit TRS. However, a UE is only aware of the TRS configuration of its serving cell. In addition, the TRS in one cell may collide with data, TRS, or CSI-RS in neighboring cells.

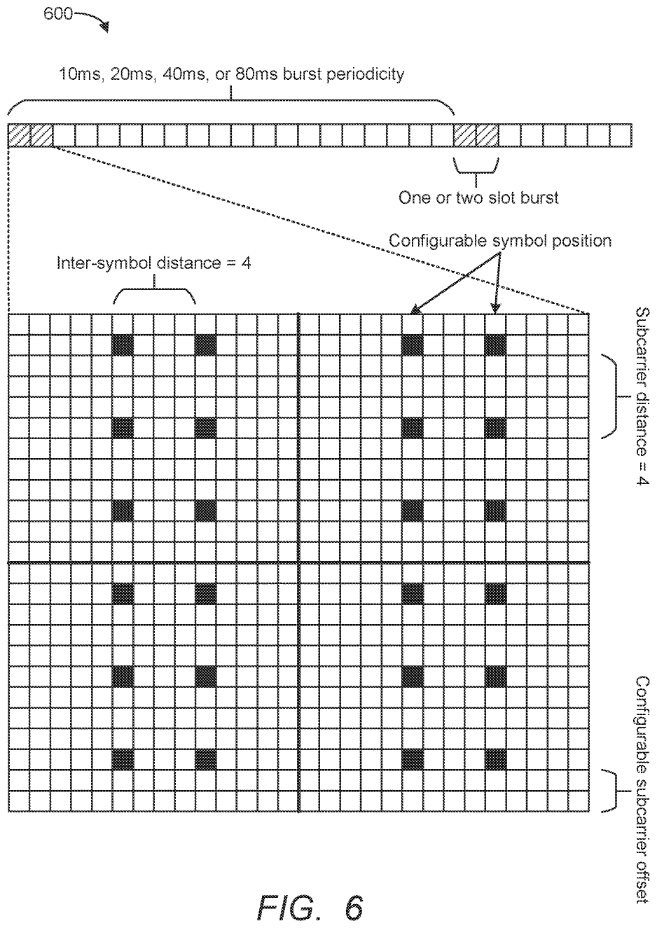

FIG. 6 is a diagram 600 illustrating an example TRS configuration, according to aspects of the disclosure. In FIG. 6, time is represented horizontally (on the X axis) with time increasing from left to right, while frequency is represented vertically (on the Y axis) with frequency increasing (or decreasing) from bottom to top. In the example of FIG. 6, two sequential slots are expanded to show the resource elements of four resource blocks making up the two slots.

As shown in FIG. 6, TRS are transmitted in a burst of one or two slots with a periodicity of 10 ms, 20 ms, 40 ms, or 80 ms. Within a slot, the positions of the symbols carrying the TRS are configurable, provided there is a four-symbol inter-symbol distance between the TRS symbols. For FR1, the permitted symbol pair positions are (4, 8), (5, 9), and (6, 10). For FR2, all symbol pair positions within one slot are allowed. In the frequency domain, there is a fixed subcarrier distance between TRS subcarriers of four subcarriers. There is also a configurable subcarrier offset within each resource block. The TRS bandwidth may be equal to the device's downlink bandwidth part (DL-BWP) (i.e., as large as 272 PRBs) or 48 PRBs.

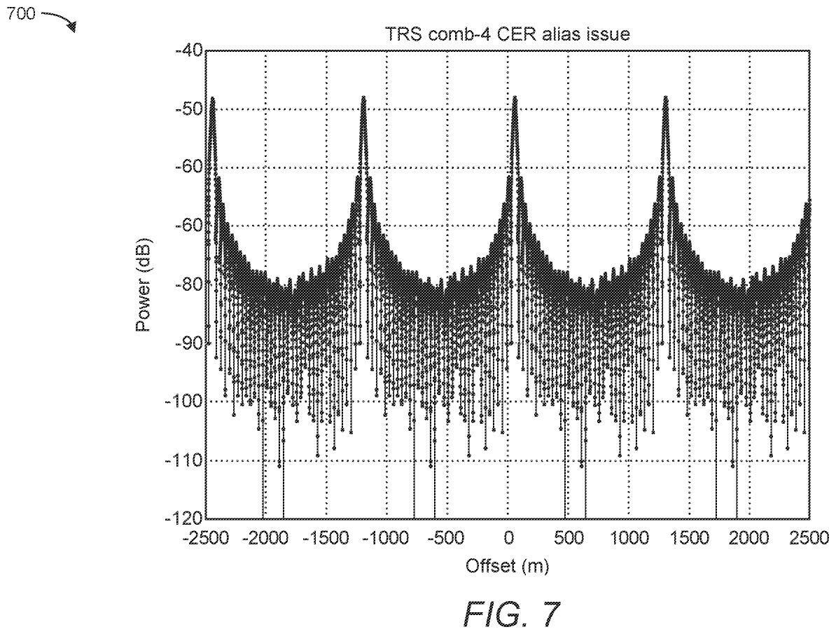

As shown in FIG. 6, TRS are not fully staggered in the frequency domain (TRS are transmitted with a comb-4 comb pattern), and therefore, four peaks are expected to be observed in the channel estimate (e.g., channel energy response (CER)) of the TRS. More specifically, because TRS are transmitted on a given symbol with gaps in the frequency domain, it results in aliasing of the channel estimate. Aliasing is a result of converting the frequency domain to the time domain when estimating the channel estimate, and appears as multiple equally sized peaks, as shown in FIG. 7. Specifically, FIG. 7 is a graph 700 of a CER estimate for a single symbol where the measured TRS is transmitted using a comb-4 pattern. As shown in FIG. 7, the CER has four significant peaks, due to the TRS being transmitted with a comb-4 pattern (i.e., on every fourth subcarrier), but only one of these peaks is the “true” peak (i.e., represents the actual time of arrival (ToA) of the TRS in that symbol). However, because the TRS in a cell is quasi-co-located with the SSB in the cell, the SSB can also be measured to solve the time-domain aliasing problem of the TRS in that cell.

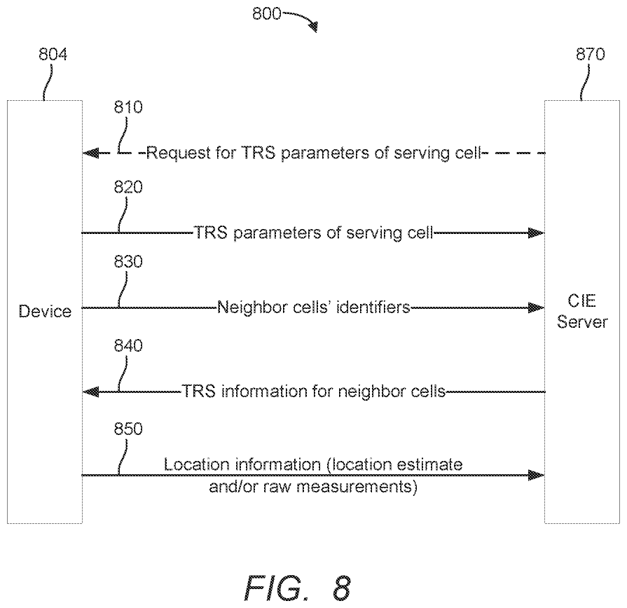

FIG. 8 illustrates an example CIE-based positioning procedure 800 using TRS, according to aspects of the disclosure. The CIE-based positioning procedure 800 may be performed between a client device 804 (e.g., a mobile device, an IoT device, etc.) and a CIE server 870 (e.g., a third-party server, an OTT server, etc.).

At stage 810, a CIE server 870 optionally sends a request to a client device 804 to report TRS configuration parameters (e.g., symbol pattern, symbol offset, frequency offset, number of slots per burst, burst periodicity, scrambling identifier, QCL relation, PCI, etc.) for the device's 804 serving cell. The request may configure the device 804 to report the TRS configuration parameter periodically or when any change is determined. The request may also configure the device 804 to report only the TRS configuration for a subset of TRS detected by the device 804 based on certain criteria. For example, the request may configure the device 804 to only report the TRS configuration(s) for TRS having a signal strength above a threshold. The request may also configure the device 804 to only report TRS configurations associated to a specific component carrier, frequency band, or frequency range (e.g., FR1 and/or FR2). Further, the request may configure the device 804 to transition to an RRC connected state for the purpose of gathering the TRS configuration parameters from the network.

At stage 820, the device 804 reports the requested TRS configuration parameters to the CIE server 870. Note that the device 804 may automatically report the TRS parameters of its serving cell without receiving a request from the CIE server 870 at stage 810, such as when changing serving cells or on a periodic basis.

At stage 830, the device 804 reports the identifiers (e.g., PCIs) of any neighbor cells that it discovered through, for example, radio resource management (RRM) procedures. The device 804 may also send RSRP, RSRQ, SINR, and/or RSSI measurements associated with the PCIs. The report may include component carrier(s), frequency band(s), frequency range(s), slot offset(s), periodicity(ies), subframe-offset(s), time window(s), and/or preferred TRS configurations to be provided by the CIE server 870 (if available). These parameters can be reported in priority order.

Note that stages 820 and 830 may be a single transmission sequence or multiple transmission sequences. For example, the device 804 may transmit, and the CIE server 870 receive, both the serving cell information (e.g., the requested TRS configuration parameters) and the neighbor cell information (e.g., the identifiers of any neighbor cells) in the same data transmission (i.e., stages 820 and 830 are a single transmission sequence), or the device 804 may first transmit, and the CIE server 870 may first receive, the serving cell information and then the neighbor cell information (i.e., stages 820 and 830 are separate transmissions).

At stage 840, based on the identifiers of the neighbor cells, the CIE server 870 provides the TRS configuration for the identified neighbor cells to the device 804. The response may include one or more TRS configurations associated with a specific PCI and/or associated with SSBs from that PCI. The multiple TRS configurations may be “alternatives” for the device 804 to attempt to detect. The response may also include timestamps, validity timers, expiration timers, or the like indicating when the provided configurations are valid.

In an aspect, the CIE server 870 may have obtained the TRS information for the neighbor cells based on performing stages 810 and 820 with multiple other devices, thereby creating a crowdsourced database of the TRS parameters of multiple cells. In some cases, where the CIE server 870 does not have the TRS information for a neighbor cell indicated at stage 840, it can send a request, as at stage 810, to another device 804 that is known to have that neighbor cell as its serving cell. The CIE server 870 can thereby obtain the TRS configuration parameters for that cell from the other device 804, as at stage 820.

At stage 850, the device 804 reports location information to the CIE server 870. For UE-based positioning, the location information may be the device's 804 estimated location as determined from measurements of the TRS transmitted by the serving cell and the neighbor cells for which it received the TRS configuration information. Alternatively, or additionally, the location information may be the raw measurements of the TRS and the timestamps at which those measurements were obtained (as for UE-assisted positioning). The device 804 may also report which TRS were successfully detected, or which were not detected. That is, the device 804 may report the identifiers of the neighbor cells in which it detected or failed to detect the indicated TRS.

As will be appreciated, while the foregoing has described using TRS for positioning, the CIE-based positioning procedure 800 may instead be performed using CSI-RS or any other downlink reference signal specific to a serving cell.

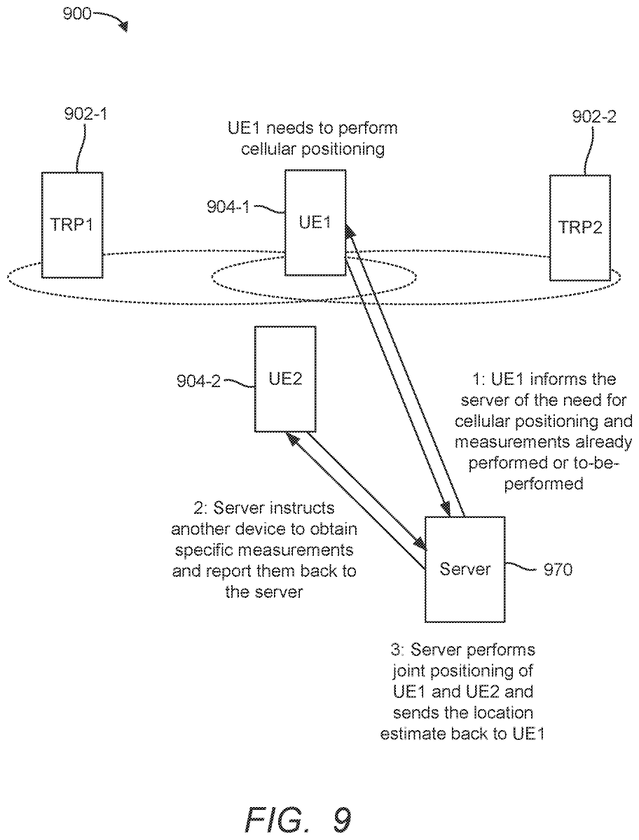

FIG. 9 illustrates an example multi-UE joint location estimation procedure 900, according to aspects of the disclosure. In a multi-UE joint location estimation procedure 900, at a high level, a set of UEs with unknown locations perform positioning measurements on the same set of TRPs, on the same frequency, and at the same (or nearly the same) time. The positioning measurements may be RSTD measurements (for DL-TDOA), UE Rx-Tx time difference measurements (for RTT), and/or path RSRP (for DL-AoD). The measurements are provided to a CIE server, where “differential” versions of the legacy techniques (e.g., DL-TDoA, RTT, etc.) are employed to make the measurements more robust to network synchronization and group delay uncertainties while the UE locations are being jointly estimated. Multi-UE joint location estimation thereby improves robustness to network uncertainties (e.g., network synchronization and group delay uncertainties).

Referring to FIG. 9, a first UE 904-1 (labeled “UE1”) needs to perform cellular positioning (e.g., has received a request for its location) involving at least a first TRP 902-1 and a second TRP 902-2 (collectively, TRPs 902). Accordingly, at stage 1, the UE 904-1 informs a server 970 (e.g., a CIE server) of the need to perform cellular positioning and of any measurements already performed or planned to be performed in the future. The UE 904-1 should inform the server 970 of the type of positioning procedure (e.g., DL-TDOA, RTT, etc.), the configuration of the reference signals (e.g., PRS, TRS, CSI-RS, etc.) measured or to be measured, and the TRPs 902 measured or to be measured.

At stage 2, the server 970 instructs one or more other devices (illustrated as a second UE 904-2 and labeled “UE2”), optionally with unknown locations, to obtain specific measurements and report them back to the server 970. The measurements should be the same type as the measurements already performed or planned to be performed by the UE 904-1. The measurements should also be performed on the same reference signal resources transmitted by the same TRPs 902. The instructions from the server 970 to the other devices may therefore include the configuration of the reference signal resources measured or to be measured by the first UE 904-1. Alternatively, the instructions may be to obtain the reference signal configuration information for the identified TRPs 902 from the other devices'location server(s). After performing/obtaining the requested measurements, the other devices report the measurements to the server 970.

At stage 3, the server 970 performs joint positioning of the first UE 904-1 and the second UE 904-2 and sends UE 904-1 the location estimate determined for UE 904-1. The server 970 may also send UE 904-2 the location estimate for UE 904-2.

To perform joint positioning, the server 970 may need a large number of devices relatively close to each other measuring the same reference signal resources from the same TRPs. For example, since the devices are measuring the same TRPs, the device may be IoT devices that are “clustered together” (e.g., within the same room or factory).

When using OTT signals (e.g., TRS) for positioning, the UE will need to integrate, or aggregate, multiple measurements of the OTT signals to achieve acceptable performance (e.g., ToA accuracy) due to interference caused by multiple TRPs transmitting on the same time and frequency resources. More specifically, when a reference signal is transmitted periodically (as in the example of FIG. 6), the UE can aggregate, or combine, repetitions of the reference signal in the time domain to improve the signal strength (gain) of the measured reference signal.

There are two types of integration, coherent integration and non-coherent integration. Coherent integration (or coherent combining) is the combining of reference signal measurements in both the phase and amplitude domains. For example, assume a first reference signal measurement (denoted “RSI”) is associated with a first reference signal repetition (denoted “Repetition 1”) and a second reference signal measurement (denoted “RS2”) is associated with a second reference signal repetition (denoted “Repetition 2”). Both reference signal measurements RS1 and RS2 are in the complex domain. Adding RS1 and RS2 together in the complex domain is coherent combining, whereas adding the absolute value of RS1 and the absolute value of RS2 is non-coherent combining. Note that phase coherency of reference signal measurements across repetitions is necessary for coherent combining.

For coherent integration, symbols within the same slot (or possibly within multiple slots in the same reference signal burst) can be integrated coherently since the phase would not have changed significantly in that time duration. For non-coherent integration, across bursts (e.g., one TRS burst is 20 slots), the channel/device phase is likely to have changed enough for coherent integration to not be effective. In that case, the UE can non-coherently combine multiple measurements.

The present disclosure provides techniques to improve the performance of positioning estimation using 5G OTT signals by making use of a multi-hypothesis framework for any measurements reported by the UE to the CIE server. More specifically, a UE can track multiple hypotheses for a positioning measurement (e.g., ToA) based on various levels of integration and report them back to the CIE server.

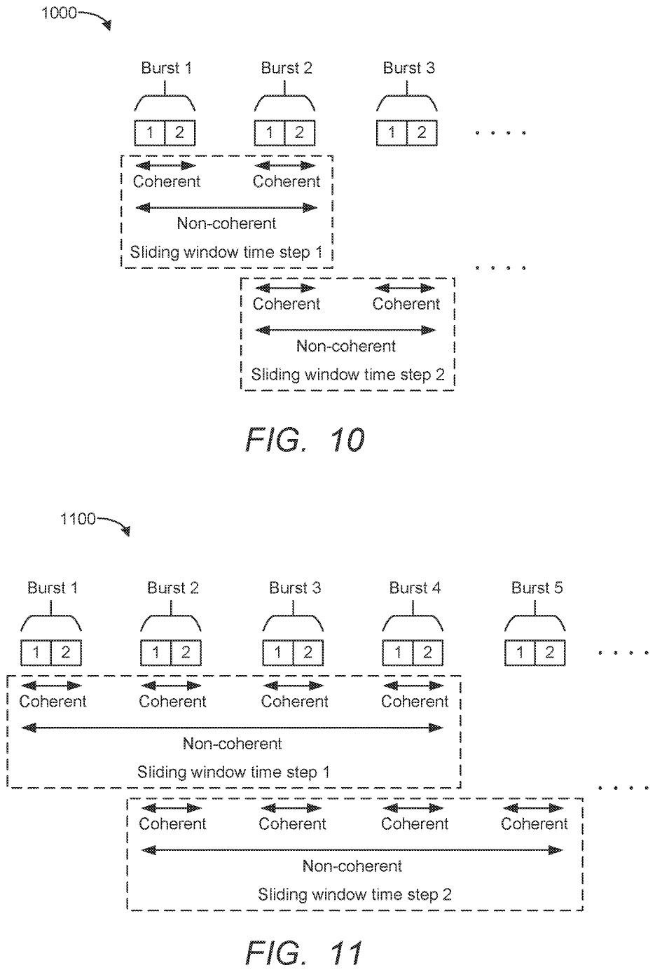

FIG. 10 is a diagram 1000 illustrating an example hypothesis in which ToA estimation is based on a sliding window of channel measurements, according to aspects of the disclosure. In the example of FIG. 10, two-slot bursts of a TRS (labeled “Burst 1,” “Burst 2,” and so on) are transmitted periodically (e.g., every 20 slots). The hypothesis in the example of FIG. 10 is to determine the ToA of the TRS by coherently integrating the TRS within each burst (i.e., within the two slots of each burst) and non-coherently integrating the TRS across two consecutive bursts. This hypothesis is shown by a sliding window sized to include two consecutive bursts. Thus, in the example of FIG. 10, the UE determines ToAs of the TRS by integrating measurements of Burst 1 and Burst 2 in the first sliding window, then Burst 2 and Burst 3 in the next sliding window, and so on. A two-burst sliding window can be efficiently implemented by discarding the last channel measurement and adding the newest one.

FIG. 11 is a diagram 1100 illustrating another example hypothesis in which ToA estimation is based on a sliding window of channel measurements, according to aspects of the disclosure. In the example of FIG. 11, two-slot bursts of a TRS (labeled “Burst 1,” “Burst 2,” and so on) are transmitted periodically (e.g., every 20 slots). The hypothesis in the example of FIG. 11 is to determine the ToA of the TRS by coherently integrating the TRS within each burst (i.e., within the two slots of each burst) and non-coherently integrating the TRS across four consecutive bursts. This hypothesis is shown by a sliding window sized to include four consecutive bursts. Thus, in the example of FIG. 11, the UE determines ToAs of the TRS by integrating measurements of Burst 1 to Burst 4 in the first sliding window, then Burst 2 to Burst 5 in the next sliding window, and so on.

As will be appreciated, while FIGS. 10 and 11 illustrate sliding windows of two and four bursts, respectively, the hypothesis/sliding window may be configured to include any number of bursts. In addition, where the TRS periodicity is lower (e.g., 10 slots), the UE may test a hypothesis where TRS are coherently integrated across two or more consecutive bursts, rather than just across the slot(s) of one burst.

On the server side, the server can determine which hypotheses resulted in more outliers or better performance in terms of SINR and/or other signal strength measurement(s). More specifically, the UE reports each hypothesis and the positioning measurements (e.g., ToA) obtained using that hypothesis. For each hypothesis, the server uses the measurements obtained with that hypothesis for pruning and outlier rejection. The server may use, for example, a random sample consensus (RANSAC) method or the like. The server can then determine which hypothesis is best (e.g., results in the highest SINR, most accurate ToA estimate, etc.) for the UE.

A UE may determine the hypotheses to test on its own and report them to the server, or the server can instruct the UE as to which hypotheses to test. The length of the hypotheses (i.e., the number of bursts to combine per measurement) may be based on the mobility of the UE, channel conditions, and/or the like.

Different hypotheses may be preferrable in different scenarios. That is, a hypothesis that works well in one scenario may not be the best hypothesis in a different scenario. For example, in a high mobility scenario, the best hypothesis will likely have a short integration duration (e.g., one or two bursts). Thus, a high mobility hypothesis with a long integration duration will likely suffer performance degradation due to decreased channel coherence time. In a low mobility and/or high interference scenario, however, the best hypothesis will likely have a longer integration duration, even if that requires using non-coherent integration.

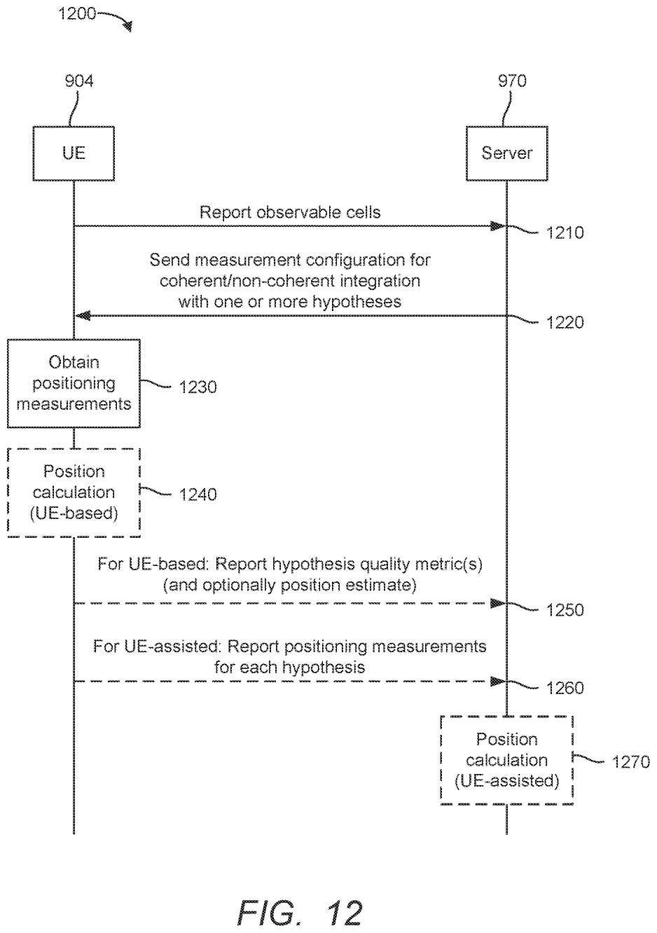

FIG. 12 illustrates a method 1200 for calculating the position of a UE 904 based on multiple hypotheses, according to aspects of the disclosure. The method 1200 may be part of a positioning procedure with one or more TRPs (not shown), such as the TDOA-based positioning procedure illustrated in FIG. 4.

At stage 1210, the UE 904 reports to the server 970 information about any observable (i.e., measurable) cells. The information may include the TRS configuration(s) and/or cell identifiers (e.g., PCI, NR CGI) and timestamp(s) (of the observation/measurement) of the observed cells. The UE 904 may only be able to obtain the TRS configuration of its serving cell, or may be able to obtain/determine the TRS configuration for any neighboring cells.

At stage 1220, the server 970 sends to the UE 904 the measurement configuration for coherent and/or non-coherent integration using one or more hypotheses. For example, the server 970 may configure the UE 904 with a per-TRP association to one or more sliding windows, whether to perform coherent integration, non-coherent integration, or both, the length of the window(s), and the like. For example, the UE 904 may be configured with the two-burst hypothesis illustrated in FIG. 10 and the four-burst hypothesis illustrated in FIG. 11.

At stage 1230, the UE 904 performs/obtains multiple positioning measurements (e.g., ToA) using different coherent and/or non-coherent hypotheses as per the configuration received at stage 1220. For example, if the UE 904 was configured with the two-burst hypothesis illustrated in FIG. 10 and the four-burst hypothesis illustrated in FIG. 11, the UE 904 would perform/obtain one or more positioning measurements using the two-burst hypothesis and one or more positioning measurements obtained using the four-burst hypothesis.

At stage 1240, if the positioning procedure is UE-based, then the UE 904 calculates an estimate of its location. For example, for a TDOA-based positioning procedure, the location estimate is based on the RSTDs of the TRS received from pairs of TRPs (specifically, a reference TRP paired with multiple non-reference TRPs) and the locations of the TRPs, as discussed above with reference to FIG. 4. The server 970 may indicate which TRP to use as the reference TRP, or the UE 904 may select the reference TRP and report it to the server 970, or the UE 904 may use its serving cell as the reference TRP. The server 970 may also provide the locations of the measured TRPs.

As part of calculating the location estimate, the UE 904 also calculates a quality metric for each hypothesis the UE 904 was configured with at stage 1220. The quality metric indicates the quality of the positioning measurement(s) obtained using a hypothesis. The quality metric may be a function of, for example, the number of outliers (measurements that are inconsistent with other measurements and/or other known information) and/or inliers (measurements that are consistent with other measurements and/or other known information). The quality metric may be per TRP (i.e., may indicate how the hypothesis performed per TRP) or for all measured TRPs.

At stage 1250, the UE 904 reports the hypothesis quality metric(s) to the server 970 and, optionally, the location estimate calculated at stage 1240. The UE 904 may report the quality metric(s) for only the best hypothesis or for all hypotheses with which the UE 904 was configured at stage 1220. The report may include any thresholds used for outlier and/or inlier determination, the number of outliers and/or inliers, and the like. The report may also indicate whether the quality metric(s) are per-TRP or for all TRPs.

At stage 1260, if the positioning procedure is UE-assisted, the UE 904 reports the positioning measurements (e.g., ToA) obtained using different coherent and/or non-coherent hypotheses as per the configuration received at stage 1220. For example, if the UE 904 was configured with the two-burst hypothesis illustrated in FIG. 10 and the four-burst hypothesis illustrated in FIG. 11, the UE 904 would report one or more positioning measurements obtained using the two-burst hypothesis and one or more positioning measurements obtained using the four-burst hypothesis. The report should identify, for each measurement, which TRP was measured (measuring the TRS or other downlink channel from a TRP is referred to as “measuring the TRP”) and the hypothesis used to determine the measurement.

At stage 1270, the server 970 calculates an estimate of the location of the UE 904 based on the measurements reported at stage 1260 and the known locations of the measured TRPs. For example, for a TDOA-based positioning procedure, the location estimate is based on the RSTDs of the TRS received from pairs of TRPs (specifically, a reference TRP paired with multiple non-reference TRPs) and the locations of the TRPs, as discussed above with reference to FIG. 4. The server 970

As part of calculating the location estimate for the UE 904, the server 970 may also calculate a quality metric for each hypothesis the UE 904 used to obtain the measurements reported at stage 1260. This may be the same quality metric as the UE 904 determines for UE-based positioning. The server 970 may crowdsource the best one or more hypotheses for each TRP so that it can provide better recommendations to other UEs.

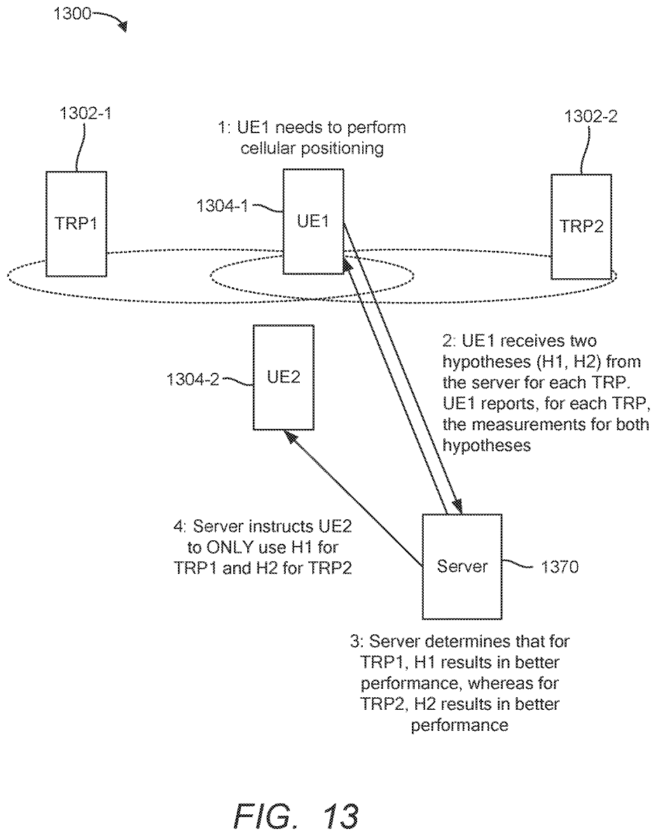

FIG. 13 illustrates an example multi-UE joint location estimation procedure 1300 using TRP-specific hypotheses, according to aspects of the disclosure. In the example of FIG. 13, two UEs 1304-1 and 1304-2 (labeled “UE1” and “UE2,” respectively, and referred to collectively as UEs 1304) can observe (i.e., measure at least TRS from) two TRPs 1302-1 and 1302-2 (labeled “TRP1” and “TRP2,” respectively, and referred to collectively as TRPs 1302).

At stage 1, the UE 1304-1 determines that it needs to perform cellular positioning. For example, the UE 1304-1 may have received a request for its location from an application running on the UE 1304-1 or may need to report its location as part of an emergency call. The UE 1304-1 indicates the need for cellular positioning to a server 1370 (e.g., a CIE server), as at stage 1 of FIG. 9, and may report any observed cells (here, TRPs 1302), as at stage 1210 of FIG. 12.

At stage 2, the server 1370 configures the UE 1304-1 with two hypotheses (denoted “H1” and “H2”) to use to obtain positioning measurements from each TRP 1302. This stage may correspond to stage 1220 in FIG. 12. In the example of FIG. 13, the hypothesis H1 may be to perform coherent processing within the two slots of a burst (as the hypothesis illustrated in FIG. 10) and the hypothesis H2 may be to perform non-coherent processing across the slots of a burst. The UE 1304-1 obtains the positioning measurements using the configured hypotheses, as at stage 1230 of FIG. 12, and reports the measurements for both hypotheses to the server 1370, as at stage 1260 of FIG. 12.

At stage 3, in the example of FIG. 13, the server 1370 determines that for TRP 1302-1, hypothesis H1 results in better performance (e.g., fewer outliers), whereas for TRP 1302-2, hypothesis H2 results in better performance. This determination may be based on the quality metric determined for each hypothesis, as described above with reference to FIG. 12.

At stage 4, the server 1370 instructs the UE 1304-2 to use only hypothesis H1 for TRP 1302-1 and only hypothesis H2 for TRP 1302-2. This may be part of the configuration at stage 2 of FIG. 9. The UE 1304-2 reports to the server 1370 the measurements of the TRPs 1302 obtained using the respective hypotheses. The server 1370 then performs joint positioning of the UEs 1304 as at stage 3 of FIG. 9.

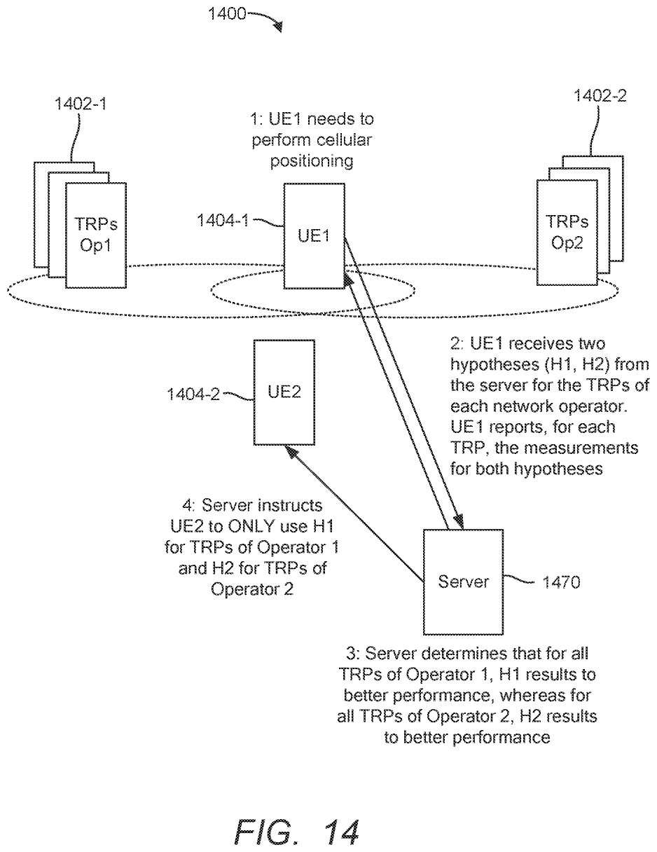

FIG. 14 illustrates an example multi-UE joint location estimation procedure 1400 using network operator-specific hypotheses, according to aspects of the disclosure. In the example of FIG. 14, two UEs 1404-1 and 1404-2 (labeled “UE1” and “UE2,” respectively, and referred to collectively as UEs 1404) can observe (i.e., measure at least TRS from) sets of TRPs 1402-1 and 1402-2 of different network operators (labeled “TRPs Op1” and “TRPs Op2,” respectively, and referred to collectively as sets of TRPs 1402).

At stage 1, the UE 1404-1 determines that it needs to perform cellular positioning, as at stage 1 of FIG. 13. The UE 1404-1 indicates the need for cellular positioning to a server 1470 (e.g., a CIE server), as at stage 1 of FIG. 9, and may report any observed cells (here, the sets of TRPs 1402), as at stage 1210 of FIG. 12.

At stage 2, the server 1470 configures the UE 1404-1 with two hypotheses (denoted “H1” and “H2”) to use to obtain positioning measurements from the TRPs of each network operator (here, the sets of TRPs 1402). This stage may correspond to stage 1220 in FIG. 12. In the example of FIG. 14, the hypothesis H1 may be to perform coherent processing within the two slots of a burst (as the hypothesis illustrated in FIG. 10) and the hypothesis H2 may be to perform non-coherent processing across the slots of a burst. The UE 1404-1 obtains the positioning measurements using the configured hypotheses, as at stage 1230 of FIG. 12, and reports the measurements for both hypotheses to the server 1470, as at stage 1260 of FIG. 12.

At stage 3, in the example of FIG. 14, the server 1470 determines that for the set of TRPs 1402-1, hypothesis H1 results in better performance (e.g., fewer outliers), whereas for the set of TRPs 1402-2, hypothesis H2 results in better performance. This determination may be based on the quality metric determined for each hypothesis, as described above with reference to FIG. 12.

At stage 4, the server 1470 instructs the UE 1404-2 to use only hypothesis H1 for the set of TRPs 1402-1 and only hypothesis H2 for the set of TRPs 1402-2. This may be part of the configuration at stage 2 of FIG. 9. The UE 1404-2 reports to the server 1470 the measurements of the TRPs 1402 obtained using the respective hypotheses. The server 1470 then performs joint positioning of the UEs 1404 as at stage 3 of FIG. 9.

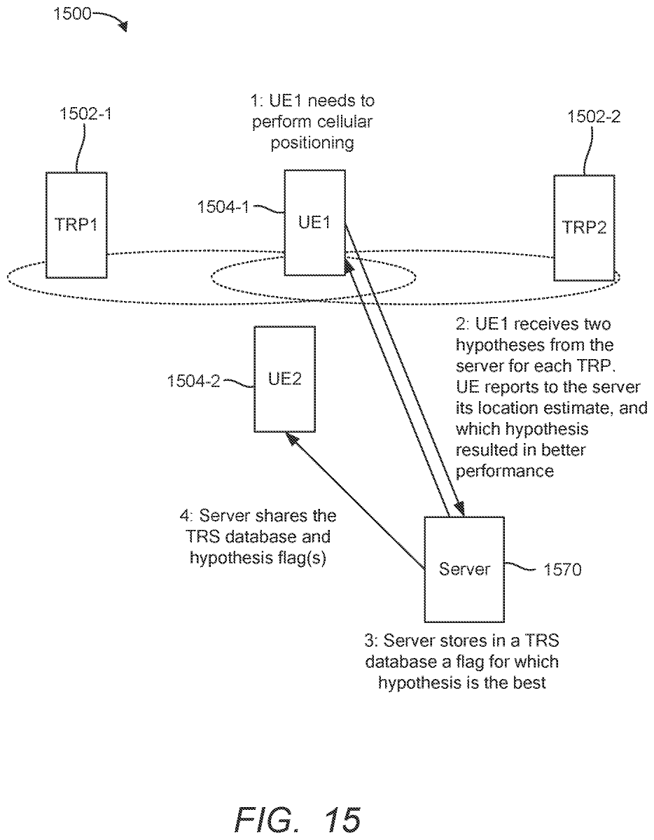

FIG. 15 illustrates an example multi-UE joint location estimation procedure 1500 using TRP-specific hypotheses for UE-based positioning, according to aspects of the disclosure. In the example of FIG. 15, two UEs 1504-1 and 1504-2 (labeled “UE1” and “UE2,” respectively, and referred to collectively as UEs 1504) can observe (i.e., measure at least TRS from) two TRPs 1502-1 and 1502-2 (labeled “TRP1” and “TRP2,” respectively, and referred to collectively as TRPs 1502).

At stage 1, the UE 1504-1 determines that it needs to perform cellular positioning, as at stage 1 of FIG. 13. The UE 1504-1 indicates the need for cellular positioning to a server 1570 (e.g., a CIE server), as at stage 1 of FIG. 9, and may report any observed cells (here, TRPs 1502), as at stage 1210 of FIG. 12.

At stage 2, the server 1570 configures the UE 1504-1 with two hypotheses (denoted “H1” and “H2”) to use to obtain positioning measurements from each TRP 1502. This stage may correspond to stage 1220 in FIG. 12. In the example of FIG. 15, the hypothesis H1 may be to perform coherent processing within the two slots of a burst (as the hypothesis illustrated in FIG. 10) and the hypothesis H2 may be to perform non-coherent processing across the slots of a burst. The UE 1504-1 obtains the positioning measurements using the configured hypotheses, as at stage 1230 of FIG. 12, calculates an estimate of its location, as at stage 1240 of FIG. 12, and reports to the server 1570 which hypothesis resulted in better performance, as at stage 1250 of FIG. 12. The report of which hypothesis resulted in better performance may include, or may be, the quality metric for that hypothesis. That is, the UE 1504 may simply identify the hypothesis that resulted in the best performance, or may provide the quality metric for that hypothesis to indicate that that hypothesis resulted in the best performance. The UE 1504 may also report its location estimate to the server 1570.

At stage 3, the server 1570 stores an indication (e.g., a flag) that the reported hypothesis resulted in the best positioning/measurement performance. More specifically, the server 1570 may maintain a database in which it stores information about the TRS transmitted by different TRPs (including TRPs 1502), such as the TRS configurations, the hypotheses tested (e.g., H1, H2), and flags indicating which hypotheses provided the best performance. The server 1570 may also store any available (e.g., reported by the UE 1504-1 or calculated by the server 1570) quality metrics associated with the tested hypotheses.

At stage 4, the server 1570 sends the TRS database, including the flags indicating the best hypotheses, to the UE 1504-2. The UE 1504-2 can then select the TRS to measure and the hypotheses to use for the measurements and report the results back to the server 1570. The server 1570 then performs joint positioning of the UEs 1504 as at stage 3 of FIG. 9. Alternatively, the UE 1504-2 may perform UE-based positioning based on the information received from the server 1570.

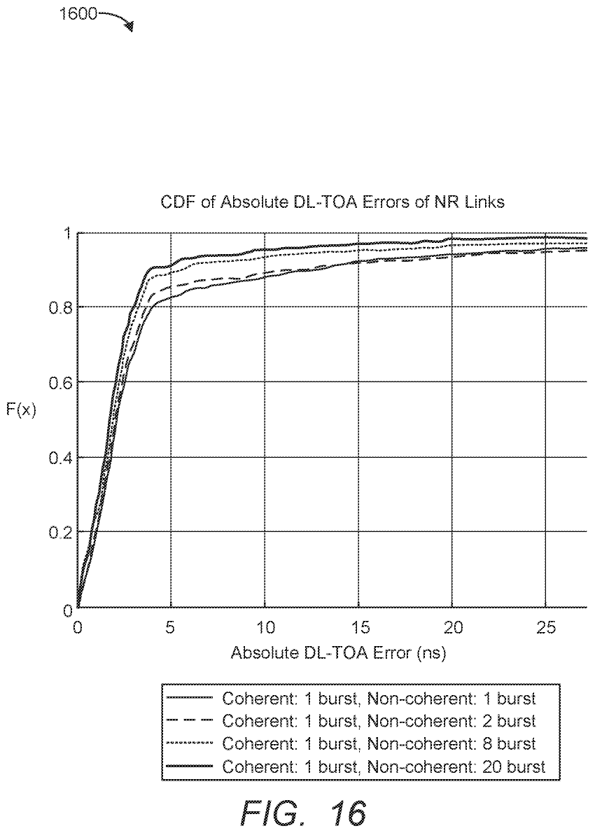

FIG. 16 is a graph 1600 of a cumulative distribution function (CDF) of absolute downlink time of arrival (DL-TOA) errors of example New Radio (NR) links, according to aspects of the disclosure. There are four hypotheses in the example of FIG. 16. In each hypothesis, the UE performs coherent processing across the slots of one burst and then non-coherent processing across some number of bursts (specifically, 1, 2, 8, and 20 bursts).

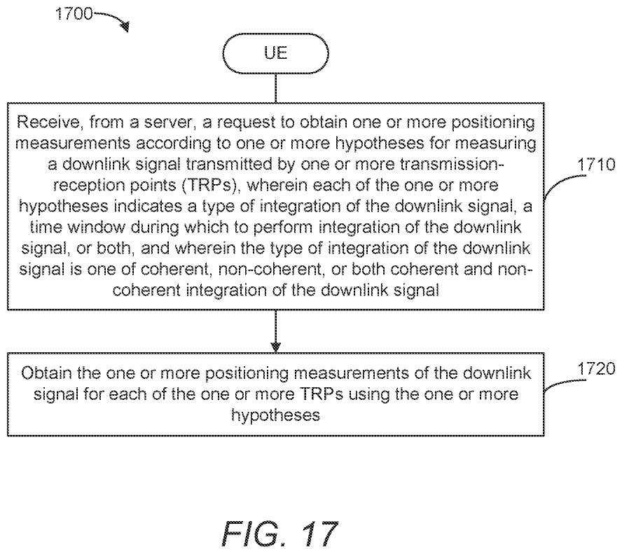

FIG. 17 illustrates an example method 1700 of wireless communication, according to aspects of the disclosure. In an aspect, method 1700 may be performed by a UE (e.g., any of the UEs described herein).

At 1710, the UE receives, from a server (e.g., any of the servers described above with reference to FIGS. 8-15), a request to obtain one or more positioning measurements according to one or more hypotheses for measuring a downlink signal transmitted by one or more TRPs, as at stage 1220 of FIG. 12 and stage 2 of FIGS. 13-15, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal. In an aspect, operation 1710 may be performed by the one or more WWAN transceivers 310, the one or more processors 332, memory 340, and/or positioning component 342, any or all of which may be considered means for performing this operation.

At 1720, the UE obtains the one or more positioning measurements of the downlink signal for each of the one or more TRPs using the one or more hypotheses, as at stage 1230 of FIG. 12. In an aspect, operation 1720 may be performed by the one or more WWAN transceivers 310, the one or more processors 332, memory 340, and/or positioning component 342, any or all of which may be considered means for performing this operation.

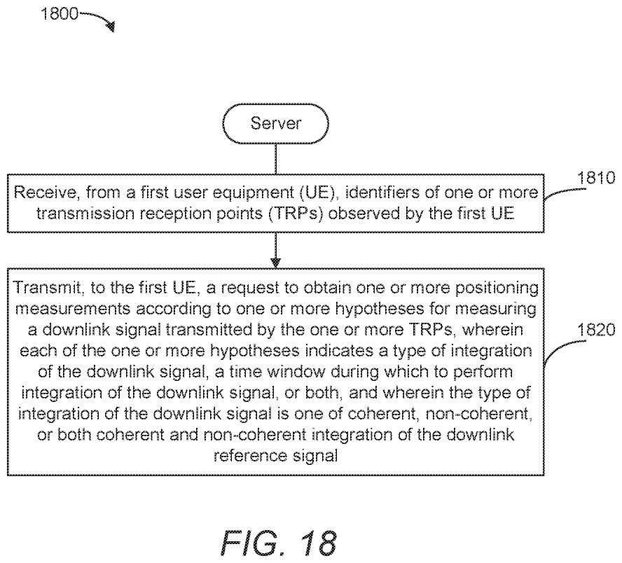

FIG. 18 illustrates an example method 1800 of communication, according to aspects of the disclosure. In an aspect, method 1800 may be performed by a server (e.g., any of the servers described above with reference to FIGS. 8-15).

At 1810, the server receives, from a first UE (e.g., any of the UEs described herein), identifiers of one or more TRPs observed by the first UE, as at stage 1210 of FIG. 12. In an aspect, operation 1810 may be performed by the one or more network transceivers 390, the one or more processors 394, memory 396, and/or positioning component 398, any or all of which may be considered means for performing this operation.

At 1820, the server transmits, to the first UE, a request to obtain one or more positioning measurements according to one or more hypotheses for measuring a downlink signal transmitted by the one or more TRPs, as at stage 1220 of FIG. 12 and stage 2 of FIGS. 13-15, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink reference signal. In an aspect, operation 1820 may be performed by the one or more network transceivers 390, the one or more processors 394, memory 396, and/or positioning component 398, any or all of which may be considered means for performing this operation.

As will be appreciated, a technical advantage of the methods 1700 and 1800 is improved OTT positioning performance by determining and using the best coherency hypothesis for measuring downlink signals from one or more TRPs.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), comprising: receiving, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal; and obtaining the one or more positioning measurements of the downlink signal for each of the one or more TRPs using the one or more hypotheses.

Clause 2. The method of clause 1, further comprising: reporting, to the server, identifiers of the one or more TRPs, wherein the one or more hypotheses are received in response to reporting the identifiers of the one or more TRPs.

Clause 3. The method of any of clauses 1 to 2, further comprising: reporting, to the server, a time and frequency resource configuration of the downlink signal for at least a serving TRP of the one or more TRPs.

Clause 4. The method of any of clauses 1 to 3, further comprising: reporting, to the server, the one or more positioning measurements to enable the server to calculate a position estimate for the UE.

Clause 5. The method of any of clauses 1 to 4, further comprising: calculating, for each TRP of the one or more TRPs, hypothesis quality metrics for the one or more hypotheses based on the one or more positioning measurements of the downlink signal transmitted by the TRP.

Clause 6. The method of clause 5, further comprising: reporting, to the server, the hypothesis quality metrics for each TRP of the one or more TRPs; or reporting, to the server, for each TRP of the one or more TRPs, based on the hypothesis quality metrics, an indication of which hypothesis of the one or more hypotheses provided better measurement performance for the one or more positioning measurements of the downlink signal transmitted by the TRP than remaining hypotheses of the one or more hypotheses.

Clause 7. The method of any of clauses 5 to 6, wherein each hypothesis quality metric is based on a number of outlier measurements, inlier measurements, or both outlier measurements and inlier measurements resulting from a respective hypothesis of the one or more hypotheses.

Clause 8. The method of any of clauses 1 to 7, further comprising: calculating a position estimate for the UE based on the one or more positioning measurements and locations of the one or more TRPs.

Clause 9. The method of any of clauses 1 to 8, wherein obtaining the one or more positioning measurements of the downlink signal comprises: applying, for each TRP of the one or more TRPs, all of the one or more hypotheses to the downlink signal transmitted by the TRP; or applying, for each TRP of the one or more TRPs, one of the one or more hypotheses to the downlink signal transmitted by the TRP.

Clause 10. The method of any of clauses 1 to 9, wherein the time window comprises one or more bursts of one or more slots of the downlink signal.

Clause 11. The method of any of clauses 1 to 10, wherein the downlink signal comprises a tracking reference signal (TRS), a positioning reference signal (PRS), or a channel state information reference signal (CSI-RS).

Clause 12. The method of any of clauses 1 to 11, wherein the one or more positioning measurements comprise: one or more downlink time of arrival (DL-TOA) measurements, one or more reference signal time difference (RSTD) measurements, one or more reference signal received power (RSRP) measurements, one or more path RSRPs measurements, one or more reception-to-transmission (Rx-Tx) time difference measurements, one or more Doppler measurements, or any combination thereof.

Clause 13. The method of any of clauses 1 to 12, wherein the server comprises a connected intelligent edge (CIE) server or an over-the-top (OTT) server.

Clause 14. A method of communication performed by a server, comprising: receiving, from a first user equipment (UE), identifiers of one or more transmission-reception points (TRPs) observed by the first UE; and transmitting, to the first UE, a request to obtain one or more positioning measurements according to one or more hypotheses for measuring a downlink signal transmitted by the one or more TRPs, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal.

Clause 15. The method of clause 14, further comprising: receiving, from the first UE, the one or more positioning measurements of the downlink signal for each of the one or more TRPs, the one or more positioning measurements obtained using the one or more hypotheses; and determining, for each TRP of the one or more TRPs, which hypothesis of the one or more hypotheses provided better measurement performance for the one or more positioning measurements of the downlink signal transmitted by the TRP than remaining hypotheses of the one or more hypotheses.

Clause 16. The method of clause 15, further comprising: transmitting, to a second UE, for each TRP of the one or more TRPs, an indication to use the hypothesis of the one or more hypotheses that provided the better measurement performance for the TRP than remaining hypotheses of the one or more hypotheses to obtain positioning measurements of the downlink signal transmitted by the TRP.

Clause 17. The method of any of clauses 15 to 16, wherein: the one or more TRPs comprise a first set of TRPs of a first network operator and a second set of TRPs of a second network operator, a first hypothesis of the one or more hypotheses is determined to provide better measurement performance for the one or more positioning measurements of the downlink signal transmitted by the first set of TRPs than remaining hypotheses of the one or more hypotheses, and a second hypothesis of the one or more hypotheses is determined to provide better measurement performance for the one or more positioning measurements of the downlink signal transmitted by the second set of TRPs than remaining hypotheses of the one or more hypotheses.

Clause 18. The method of clause 17, further comprising: transmitting, to a second UE, a first indication to use the first hypothesis to obtain positioning measurements of the downlink signal transmitted by the first set of TRPs; and transmitting, to the second UE, a second indication to use the second hypothesis to obtain the positioning measurements of the downlink signal transmitted by the second set of TRPs.

Clause 19. The method of any of clauses 14 to 18, further comprising: receiving, from the first UE, for each TRP of the one or more TRPs, hypothesis quality metrics for the one or more hypotheses based on the one or more positioning measurements of the downlink signal transmitted by the TRP.

Clause 20. The method of clause 19, further comprising: transmitting, to a second UE, for each TRP of the one or more TRPs, based on the hypothesis quality metrics for the TRP, an indication to use a hypothesis of the one or more hypotheses that provided better measurement performance for the TRP than remaining hypotheses of the one or more hypotheses to obtain positioning measurements of the downlink signal transmitted by the TRP.

Clause 21. The method of any of clauses 19 to 20, wherein each hypothesis quality metric is based on a number of outlier measurements, inlier measurements, or both outlier measurements and inlier measurements resulting from a respective hypothesis of the one or more hypotheses.

Clause 22. The method of any of clauses 14 to 21, further comprising: receiving, from the first UE, for each TRP of the one or more TRPs, an indication of which hypothesis of the one or more hypotheses provided better measurement performance for the one or more positioning measurements of the downlink signal transmitted by the TRP than remaining hypotheses of the one or more hypotheses.

Clause 23. The method of clause 22, further comprising: transmitting, to a second UE, for each TRP of the one or more TRPs, an indication to use the hypothesis of the one or more hypotheses that provided the better measurement performance for the TRP than the remaining hypotheses of the one or more hypotheses to obtain positioning measurements of the downlink signal transmitted by the TRP.

Clause 24. The method of any of clauses 14 to 23, further comprising: receiving, from the first UE, a time and frequency resource configuration of the downlink signal for at least a serving TRP of the one or more TRPs; and transmitting, to a second UE, the time and frequency resource configuration of the downlink signal for at least the serving TRP.

Clause 25. The method of any of clauses 14 to 24, wherein the time window comprises one or more bursts of one or more slots of the downlink signal.

Clause 26. The method of any of clauses 14 to 25, wherein the downlink signal comprises a tracking reference signal (TRS), a positioning reference signal (PRS), or a channel state information reference signal (CSI-RS).

Clause 27. The method of any of clauses 14 to 26, wherein the one or more positioning measurements comprise: one or more downlink time of arrival (DL-TOA) measurements, one or more reference signal time difference (RSTD) measurements, one or more reference signal received power (RSRP) measurements, one or more path RSRPs measurements, one or more reception-to-transmission (Rx-Tx) time difference measurements, one or more Doppler measurements, or any combination thereof.

Clause 28. The method of any of clauses 14 to 27, wherein the server comprises a connected intelligent edge (CIE) server or an over-the-top (OTT) server.

Clause 29. A user equipment (UE), comprising: a memory; at least one transceiver; and at least one processor communicatively coupled to the memory and the at least one transceiver, the at least one processor configured to: receive, via the at least one transceiver, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal; and obtain the one or more positioning measurements of the downlink signal for each of the one or more TRPs using the one or more hypotheses.

Clause 30. The UE of clause 29, wherein the at least one processor is further configured to: report, via the at least one transceiver, to the server, identifiers of the one or more TRPs, wherein the one or more hypotheses are received in response to reporting the identifiers of the one or more TRPs.

Clause 31. The UE of any of clauses 29 to 30, wherein the at least one processor is further configured to: report, via the at least one transceiver, to the server, a time and frequency resource configuration of the downlink signal for at least a serving TRP of the one or more TRPs.

Clause 32. The UE of any of clauses 29 to 31, wherein the at least one processor is further configured to: report, via the at least one transceiver, to the server, the one or more positioning measurements to enable the server to calculate a position estimate for the UE.

Clause 33. The UE of any of clauses 29 to 32, wherein the at least one processor is further configured to: calculate, for each TRP of the one or more TRPs, hypothesis quality metrics for the one or more hypotheses based on the one or more positioning measurements of the downlink signal transmitted by the TRP.

Clause 34. The UE of clause 33, wherein the at least one processor is further configured to: report, via the at least one transceiver, to the server, the hypothesis quality metrics for each TRP of the one or more TRPs; or report, via the at least one transceiver, to the server, for each TRP of the one or more TRPs, based on the hypothesis quality metrics, an indication of which hypothesis of the one or more hypotheses provided better measurement performance for the one or more positioning measurements of the downlink signal transmitted by the TRP than remaining hypotheses of the one or more hypotheses.

Clause 35. The UE of any of clauses 33 to 34, wherein each hypothesis quality metric is based on a number of outlier measurements, inlier measurements, or both outlier measurements and inlier measurements resulting from a respective hypothesis of the one or more hypotheses.

Clause 36. The UE of any of clauses 29 to 35, wherein the at least one processor is further configured to: calculate a position estimate for the UE based on the one or more positioning measurements and locations of the one or more TRPs.

Clause 37. The UE of any of clauses 29 to 36, wherein the at least one processor configured to obtain the one or more positioning measurements of the downlink signal comprises the at least one processor configured to: apply, for each TRP of the one or more TRPs, all of the one or more hypotheses to the downlink signal transmitted by the TRP; or apply, for each TRP of the one or more TRPs, one of the one or more hypotheses to the downlink signal transmitted by the TRP.

Clause 38. The UE of any of clauses 29 to 37, wherein the time window comprises one or more bursts of one or more slots of the downlink signal.

Clause 39. The UE of any of clauses 29 to 38, wherein the downlink signal comprises a tracking reference signal (TRS), a positioning reference signal (PRS), or a channel state information reference signal (CSI-RS).

Clause 40. The UE of any of clauses 29 to 39, wherein the one or more positioning measurements comprise: one or more downlink time of arrival (DL-TOA) measurements, one or more reference signal time difference (RSTD) measurements, one or more reference signal received power (RSRP) measurements, one or more path RSRPs measurements, one or more reception-to-transmission (Rx-Tx) time difference measurements, one or more Doppler measurements, or any combination thereof.

Clause 41. The UE of any of clauses 29 to 40, wherein the server comprises a connected intelligent edge (CIE) server or an over-the-top (OTT) server.

Clause 42. A server, comprising: a memory; at least one transceiver; and at least one processor communicatively coupled to the memory and the at least one transceiver, the at least one processor configured to: receive, via the at least one transceiver, from a first user equipment (UE), identifiers of one or more transmission-reception points (TRPs) observed by the first UE; and transmit, via the at least one transceiver, to the first UE, a request to obtain one or more positioning measurements according to one or more hypotheses for measuring a downlink signal transmitted by the one or more TRPs, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal.

Clause 43. The server of clause 42, wherein the at least one processor is further configured to: receive, via the at least one transceiver, from the first UE, the one or more positioning measurements of the downlink signal for each of the one or more TRPs, the one or more positioning measurements obtained using the one or more hypotheses; and determine, for each TRP of the one or more TRPs, which hypothesis of the one or more hypotheses provided better measurement performance for the one or more positioning measurements of the downlink signal transmitted by the TRP than remaining hypotheses of the one or more hypotheses.

Clause 44. The server of clause 43, wherein the at least one processor is further configured to: transmit, via the at least one transceiver, to a second UE, for each TRP of the one or more TRPs, an indication to use the hypothesis of the one or more hypotheses that provided the better measurement performance for the TRP than remaining hypotheses of the one or more hypotheses to obtain positioning measurements of the downlink signal transmitted by the TRP.

Clause 45. The server of any of clauses 43 to 44, wherein: the one or more TRPs comprise a first set of TRPs of a first network operator and a second set of TRPs of a second network operator, a first hypothesis of the one or more hypotheses is determined to provide better measurement performance for the one or more positioning measurements of the downlink signal transmitted by the first set of TRPs than remaining hypotheses of the one or more hypotheses, and a second hypothesis of the one or more hypotheses is determined to provide better measurement performance for the one or more positioning measurements of the downlink signal transmitted by the second set of TRPs than remaining hypotheses of the one or more hypotheses.

Clause 46. The server of clause 45, wherein the at least one processor is further configured to: transmit, via the at least one transceiver, to a second UE, a first indication to use the first hypothesis to obtain positioning measurements of the downlink signal transmitted by the first set of TRPs; and transmit, via the at least one transceiver, to the second UE, a second indication to use the second hypothesis to obtain the positioning measurements of the downlink signal transmitted by the second set of TRPs.

Clause 47. The server of any of clauses 42 to 46, wherein the at least one processor is further configured to: receive, via the at least one transceiver, from the first UE, for each TRP of the one or more TRPs, hypothesis quality metrics for the one or more hypotheses based on the one or more positioning measurements of the downlink signal transmitted by the TRP.

Clause 48. The server of clause 47, wherein the at least one processor is further configured to: transmit, via the at least one transceiver, to a second UE, for each TRP of the one or more TRPs, based on the hypothesis quality metrics for the TRP, an indication to use a hypothesis of the one or more hypotheses that provided better measurement performance for the TRP than remaining hypotheses of the one or more hypotheses to obtain positioning measurements of the downlink signal transmitted by the TRP.

Clause 49. The server of any of clauses 47 to 48, wherein each hypothesis quality metric is based on a number of outlier measurements, inlier measurements, or both outlier measurements and inlier measurements resulting from a respective hypothesis of the one or more hypotheses.

Clause 50. The server of any of clauses 42 to 49, wherein the at least one processor is further configured to: receive, via the at least one transceiver, from the first UE, for each TRP of the one or more TRPs, an indication of which hypothesis of the one or more hypotheses provided better measurement performance for the one or more positioning measurements of the downlink signal transmitted by the TRP than remaining hypotheses of the one or more hypotheses.

Clause 51. The server of clause 50, wherein the at least one processor is further configured to: transmit, via the at least one transceiver, to a second UE, for each TRP of the one or more TRPs, an indication to use the hypothesis of the one or more hypotheses that provided the better measurement performance for the TRP than the remaining hypotheses of the one or more hypotheses to obtain positioning measurements of the downlink signal transmitted by the TRP.

Clause 52. The server of any of clauses 42 to 51, wherein the at least one processor is further configured to: receive, via the at least one transceiver, from the first UE, a time and frequency resource configuration of the downlink signal for at least a serving TRP of the one or more TRPs; and transmit, via the at least one transceiver, to a second UE, the time and frequency resource configuration of the downlink signal for at least the serving TRP.

Clause 53. The server of any of clauses 42 to 52, wherein the time window comprises one or more bursts of one or more slots of the downlink signal.

Clause 54. The server of any of clauses 42 to 53, wherein the downlink signal comprises a tracking reference signal (TRS), a positioning reference signal (PRS), or a channel state information reference signal (CSI-RS).

Clause 55. The server of any of clauses 42 to 54, wherein the one or more positioning measurements comprise: one or more downlink time of arrival (DL-TOA) measurements, one or more reference signal time difference (RSTD) measurements, one or more reference signal received power (RSRP) measurements, one or more path RSRPs measurements, one or more reception-to-transmission (Rx-Tx) time difference measurements, one or more Doppler measurements, or any combination thereof.

Clause 56. The server of any of clauses 42 to 55, wherein the server comprises a connected intelligent edge (CIE) server or an over-the-top (OTT) server.

Clause 57. A user equipment (UE), comprising: means for receiving, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal; and means for obtaining the one or more positioning measurements of the downlink signal for each of the one or more TRPs using the one or more hypotheses.

Clause 58. The UE of clause 57, further comprising: means for reporting, to the server, identifiers of the one or more TRPs, wherein the one or more hypotheses are received in response to reporting the identifiers of the one or more TRPs.

Clause 59. The UE of any of clauses 57 to 58, further comprising: means for reporting, to the server, a time and frequency resource configuration of the downlink signal for at least a serving TRP of the one or more TRPs.

Clause 60. The UE of any of clauses 57 to 59, further comprising: means for reporting, to the server, the one or more positioning measurements to enable the server to calculate a position estimate for the UE.

Clause 61. The UE of any of clauses 57 to 60, further comprising: means for calculating, for each TRP of the one or more TRPs, hypothesis quality metrics for the one or more hypotheses based on the one or more positioning measurements of the downlink signal transmitted by the TRP.

Clause 62. The UE of clause 61, further comprising: means for reporting, to the server, the hypothesis quality metrics for each TRP of the one or more TRPs; or means for reporting, to the server, for each TRP of the one or more TRPs, based on the hypothesis quality metrics, an indication of which hypothesis of the one or more hypotheses provided better measurement performance for the one or more positioning measurements of the downlink signal transmitted by the TRP than remaining hypotheses of the one or more hypotheses.

Clause 63. The UE of any of clauses 61 to 62, wherein each hypothesis quality metric is based on a number of outlier measurements, inlier measurements, or both outlier measurements and inlier measurements resulting from a respective hypothesis of the one or more hypotheses.

Clause 64. The UE of any of clauses 57 to 63, further comprising: means for calculating a position estimate for the UE based on the one or more positioning measurements and locations of the one or more TRPs.

Clause 65. The UE of any of clauses 57 to 64, wherein the means for obtaining the one or more positioning measurements of the downlink signal comprises: means for applying, for each TRP of the one or more TRPs, all of the one or more hypotheses to the downlink signal transmitted by the TRP; or means for applying, for each TRP of the one or more TRPs, one of the one or more hypotheses to the downlink signal transmitted by the TRP.

Clause 66. The UE of any of clauses 57 to 65, wherein the time window comprises one or more bursts of one or more slots of the downlink signal.

Clause 67. The UE of any of clauses 57 to 66, wherein the downlink signal comprises a tracking reference signal (TRS), a positioning reference signal (PRS), or a channel state information reference signal (CSI-RS).

Clause 68. The UE of any of clauses 57 to 67, wherein the one or more positioning measurements comprise: one or more downlink time of arrival (DL-TOA) measurements, one or more reference signal time difference (RSTD) measurements, one or more reference signal received power (RSRP) measurements, one or more path RSRPs measurements, one or more reception-to-transmission (Rx-Tx) time difference measurements, one or more Doppler measurements, or any combination thereof.

Clause 69. The UE of any of clauses 57 to 68, wherein the server comprises a connected intelligent edge (CIE) server or an over-the-top (OTT) server.

Clause 70. A server, comprising: means for receiving, from a first user equipment (UE). identifiers of one or more transmission-reception points (TRPs) observed by the first UE; and means for transmitting, to the first UE, a request to obtain one or more positioning measurements according to one or more hypotheses for measuring a downlink signal transmitted by the one or more TRPs, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal.

Clause 71. The server of clause 70, further comprising: means for receiving, from the first UE, the one or more positioning measurements of the downlink signal for each of the one or more TRPs, the one or more positioning measurements obtained using the one or more hypotheses; and means for determining, for each TRP of the one or more TRPs, which hypothesis of the one or more hypotheses provided better measurement performance for the one or more positioning measurements of the downlink signal transmitted by the TRP than remaining hypotheses of the one or more hypotheses.

Clause 72. The server of clause 71, further comprising: means for transmitting, to a second UE, for each TRP of the one or more TRPs, an indication to use the hypothesis of the one or more hypotheses that provided the better measurement performance for the TRP than remaining hypotheses of the one or more hypotheses to obtain positioning measurements of the downlink signal transmitted by the TRP.

Clause 73. The server of any of clauses 71 to 72, wherein: the one or more TRPs comprise a first set of TRPs of a first network operator and a second set of TRPs of a second network operator, a first hypothesis of the one or more hypotheses is determined to provide better measurement performance for the one or more positioning measurements of the downlink signal transmitted by the first set of TRPs than remaining hypotheses of the one or more hypotheses, and a second hypothesis of the one or more hypotheses is determined to provide better measurement performance for the one or more positioning measurements of the downlink signal transmitted by the second set of TRPs than remaining hypotheses of the one or more hypotheses.

Clause 74. The server of clause 73, further comprising: means for transmitting, to a second UE, a first indication to use the first hypothesis to obtain positioning measurements of the downlink signal transmitted by the first set of TRPs; and means for transmitting, to the second UE, a second indication to use the second hypothesis to obtain the positioning measurements of the downlink signal transmitted by the second set of TRPs.

Clause 75. The server of any of clauses 70 to 74, further comprising: means for receiving, from the first UE, for each TRP of the one or more TRPs, hypothesis quality metrics for the one or more hypotheses based on the one or more positioning measurements of the downlink signal transmitted by the TRP.

Clause 76. The server of clause 75, further comprising: means for transmitting, to a second UE, for each TRP of the one or more TRPs, based on the hypothesis quality metrics for the TRP, an indication to use a hypothesis of the one or more hypotheses that provided better measurement performance for the TRP than remaining hypotheses of the one or more hypotheses to obtain positioning measurements of the downlink signal transmitted by the TRP.

Clause 77. The server of any of clauses 75 to 76, wherein each hypothesis quality metric is based on a number of outlier measurements, inlier measurements, or both outlier measurements and inlier measurements resulting from a respective hypothesis of the one or more hypotheses.

Clause 78. The server of any of clauses 70 to 77, further comprising: means for receiving, from the first UE, for each TRP of the one or more TRPs, an indication of which hypothesis of the one or more hypotheses provided better measurement performance for the one or more positioning measurements of the downlink signal transmitted by the TRP than remaining hypotheses of the one or more hypotheses.

Clause 79. The server of clause 78, further comprising: means for transmitting, to a second UE, for each TRP of the one or more TRPs, an indication to use the hypothesis of the one or more hypotheses that provided the better measurement performance for the TRP than the remaining hypotheses of the one or more hypotheses to obtain positioning measurements of the downlink signal transmitted by the TRP.

Clause 80. The server of any of clauses 70 to 79, further comprising: means for receiving, from the first UE, a time and frequency resource configuration of the downlink signal for at least a serving TRP of the one or more TRPs; and means for transmitting, to a second UE, the time and frequency resource configuration of the downlink signal for at least the serving TRP.

Clause 81. The server of any of clauses 70 to 80, wherein the time window comprises one or more bursts of one or more slots of the downlink signal.

Clause 82. The server of any of clauses 70 to 81, wherein the downlink signal comprises a tracking reference signal (TRS), a positioning reference signal (PRS), or a channel state information reference signal (CSI-RS).

Clause 83. The server of any of clauses 70 to 82, wherein the one or more positioning measurements comprise: one or more downlink time of arrival (DL-TOA) measurements, one or more reference signal time difference (RSTD) measurements, one or more reference signal received power (RSRP) measurements, one or more path RSRPs measurements, one or more reception-to-transmission (Rx-Tx) time difference measurements, one or more Doppler measurements, or any combination thereof.

Clause 84. The server of any of clauses 70 to 83, wherein the server comprises a connected intelligent edge (CIE) server or an over-the-top (OTT) server.

Clause 85. A non-transitory computer-readable medium storing computer-executable instructions that, when executed by a user equipment (UE), cause the UE to: receive, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal; and obtain the one or more positioning measurements of the downlink signal for each of the one or more TRPs using the one or more hypotheses.

Clause 86, The non-transitory computer-readable medium of clause 85, further comprising computer-executable instructions that, when executed by the UE, cause the UE to: report, to the server, identifiers of the one or more TRPs, wherein the one or more hypotheses are received in response to reporting the identifiers of the one or more TRPs.

Clause 87. The non-transitory computer-readable medium of any of clauses 85 to 86, further comprising computer-executable instructions that, when executed by the UE, cause the UE to: report, to the server, a time and frequency resource configuration of the downlink signal for at least a serving TRP of the one or more TRPs.

Clause 88. The non-transitory computer-readable medium of any of clauses 85 to 87, further comprising computer-executable instructions that, when executed by the UE, cause the UE to: report, to the server, the one or more positioning measurements to enable the server to calculate a position estimate for the UE.

Clause 89. The non-transitory computer-readable medium of any of clauses 85 to 88, further comprising computer-executable instructions that, when executed by the UE, cause the UE to: calculate, for each TRP of the one or more TRPs, hypothesis quality metrics for the one or more hypotheses based on the one or more positioning measurements of the downlink signal transmitted by the TRP.

Clause 90. The non-transitory computer-readable medium of clause 89, further comprising computer-executable instructions that, when executed by the UE, cause the UE to: report, to the server, the hypothesis quality metrics for each TRP of the one or more TRPs; or report, to the server, for each TRP of the one or more TRPs, based on the hypothesis quality metrics, an indication of which hypothesis of the one or more hypotheses provided better measurement performance for the one or more positioning measurements of the downlink signal transmitted by the TRP than remaining hypotheses of the one or more hypotheses.

Clause 91. The non-transitory computer-readable medium of any of clauses 89 to 90, wherein each hypothesis quality metric is based on a number of outlier measurements, inlier measurements, or both outlier measurements and inlier measurements resulting from a respective hypothesis of the one or more hypotheses.

Clause 92. The non-transitory computer-readable medium of any of clauses 85 to 91, further comprising computer-executable instructions that, when executed by the UE, cause the UE to: calculate a position estimate for the UE based on the one or more positioning measurements and locations of the one or more TRPs.

Clause 93. The non-transitory computer-readable medium of any of clauses 85 to 92, wherein the computer-executable instructions that, when executed by the UE, cause the UE to obtain the one or more positioning measurements of the downlink signal comprise computer-executable instructions that, when executed by the UE, cause the UE to: apply, for each TRP of the one or more TRPs, all of the one or more hypotheses to the downlink signal transmitted by the TRP; or apply, for each TRP of the one or more TRPs, one of the one or more hypotheses to the downlink signal transmitted by the TRP.

Clause 94. The non-transitory computer-readable medium of any of clauses 85 to 93, wherein the time window comprises one or more bursts of one or more slots of the downlink signal.

Clause 95. The non-transitory computer-readable medium of any of clauses 85 to 94, wherein the downlink signal comprises a tracking reference signal (TRS), a positioning reference signal (PRS), or a channel state information reference signal (CSI-RS).

Clause 96. The non-transitory computer-readable medium of any of clauses 85 to 95, wherein the one or more positioning measurements comprise: one or more downlink time of arrival (DL-TOA) measurements, one or more reference signal time difference (RSTD) measurements, one or more reference signal received power (RSRP) measurements, one or more path RSRPs measurements, one or more reception-to-transmission (Rx-Tx) time difference measurements, one or more Doppler measurements, or any combination thereof.

Clause 97. The non-transitory computer-readable medium of any of clauses 85 to 96, wherein the server comprises a connected intelligent edge (CIE) server or an over-the-top (OTT) server.

Clause 98. A non-transitory computer-readable medium storing computer-executable instructions that, when executed by a server, cause the server to: receive, from a first user equipment (UE), identifiers of one or more transmission-reception points (TRPs) observed by the first UE; and transmit, to the first UE, a request to obtain one or more positioning measurements according to one or more hypotheses for measuring a downlink signal transmitted by the one or more TRPs, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal.

Clause 99. The non-transitory computer-readable medium of clause 98, further comprising computer-executable instructions that, when executed by the server, cause the server to: receive, from the first UE, the one or more positioning measurements of the downlink signal for each of the one or more TRPs, the one or more positioning measurements obtained using the one or more hypotheses; and determine, for each TRP of the one or more TRPs, which hypothesis of the one or more hypotheses provided better measurement performance for the one or more positioning measurements of the downlink signal transmitted by the TRP than remaining hypotheses of the one or more hypotheses.

Clause 100. The non-transitory computer-readable medium of clause 99, further comprising computer-executable instructions that, when executed by the server, cause the server to: transmit, to a second UE, for each TRP of the one or more TRPs, an indication to use the hypothesis of the one or more hypotheses that provided the better measurement performance for the TRP than remaining hypotheses of the one or more hypotheses to obtain positioning measurements of the downlink signal transmitted by the TRP.

Clause 101. The non-transitory computer-readable medium of any of clauses 99 to 100, wherein: the one or more TRPs comprise a first set of TRPs of a first network operator and a second set of TRPs of a second network operator, a first hypothesis of the one or more hypotheses is determined to provide better measurement performance for the one or more positioning measurements of the downlink signal transmitted by the first set of TRPs than remaining hypotheses of the one or more hypotheses, and a second hypothesis of the one or more hypotheses is determined to provide better measurement performance for the one or more positioning measurements of the downlink signal transmitted by the second set of TRPs than remaining hypotheses of the one or more hypotheses.

Clause 102. The non-transitory computer-readable medium of clause 101, further comprising computer-executable instructions that, when executed by the server, cause the server to: transmit, to a second UE, a first indication to use the first hypothesis to obtain positioning measurements of the downlink signal transmitted by the first set of TRPs; and transmit, to the second UE, a second indication to use the second hypothesis to obtain the positioning measurements of the downlink signal transmitted by the second set of TRPs.

Clause 103. The non-transitory computer-readable medium of any of clauses 98 to 102, further comprising computer-executable instructions that, when executed by the server, cause the server to: receive, from the first UE, for each TRP of the one or more TRPs, hypothesis quality metrics for the one or more hypotheses based on the one or more positioning measurements of the downlink signal transmitted by the TRP.

Clause 104. The non-transitory computer-readable medium of clause 103, further comprising computer-executable instructions that, when executed by the server, cause the server to: transmit, to a second UE, for each TRP of the one or more TRPs, based on the hypothesis quality metrics for the TRP, an indication to use a hypothesis of the one or more hypotheses that provided better measurement performance for the TRP than remaining hypotheses of the one or more hypotheses to obtain positioning measurements of the downlink signal transmitted by the TRP.

Clause 105. The non-transitory computer-readable medium of any of clauses 103 to 104, wherein each hypothesis quality metric is based on a number of outlier measurements, inlier measurements, or both outlier measurements and inlier measurements resulting from a respective hypothesis of the one or more hypotheses.

Clause 106. The non-transitory computer-readable medium of any of clauses 98 to 105, further comprising computer-executable instructions that, when executed by the server, cause the server to: receive, from the first UE, for each TRP of the one or more TRPs, an indication of which hypothesis of the one or more hypotheses provided better measurement performance for the one or more positioning measurements of the downlink signal transmitted by the TRP than remaining hypotheses of the one or more hypotheses.

Clause 107. The non-transitory computer-readable medium of clause 106, further comprising computer-executable instructions that, when executed by the server, cause the server to: transmit, to a second UE, for each TRP of the one or more TRPs, an indication to use the hypothesis of the one or more hypotheses that provided the better measurement performance for the TRP than the remaining hypotheses of the one or more hypotheses to obtain positioning measurements of the downlink signal transmitted by the TRP.

Clause 108. The non-transitory computer-readable medium of any of clauses 98 to 107, further comprising computer-executable instructions that, when executed by the server, cause the server to: receive, from the first UE, a time and frequency resource configuration of the downlink signal for at least a serving TRP of the one or more TRPs; and transmit, to a second UE, the time and frequency resource configuration of the downlink signal for at least the serving TRP.

Clause 109. The non-transitory computer-readable medium of any of clauses 98 to 108, wherein the time window comprises one or more bursts of one or more slots of the downlink signal.

Clause 110. The non-transitory computer-readable medium of any of clauses 98 to 109, wherein the downlink signal comprises a tracking reference signal (TRS), a positioning reference signal (PRS), or a channel state information reference signal (CSI-RS).

Clause 111. The non-transitory computer-readable medium of any of clauses 98 to 110, wherein the one or more positioning measurements comprise: one or more downlink time of arrival (DL-TOA) measurements, one or more reference signal time difference (RSTD) measurements, one or more reference signal received power (RSRP) measurements, one or more path RSRPs measurements, one or more reception-to-transmission (Rx-Tx) time difference measurements, one or more Doppler measurements, or any combination thereof.

Clause 112. The non-transitory computer-readable medium of any of clauses 98 to 111, wherein the server comprises a connected intelligent edge (CIE) server or an over-the-top (OTT) server.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless communication performed by a user equipment (UE), comprising:
receiving, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal; and
obtaining the one or more positioning measurements of the downlink signal for each of the one or more TRPs using the one or more hypotheses.

2. The method of claim 1, further comprising:
reporting, to the server, identifiers of the one or more TRPs, wherein the one or more hypotheses are received in response to reporting the identifiers of the one or more TRPs.

3. The method of claim 1, further comprising:
reporting, to the server, a time and frequency resource configuration of the downlink signal for at least a serving TRP of the one or more TRPs.

4. The method of claim 1, further comprising:
reporting, to the server, the one or more positioning measurements to enable the server to calculate a position estimate for the UE.

5. The method of claim 1, further comprising:
calculating, for each TRP of the one or more TRPs, hypothesis quality metrics for the one or more hypotheses based on the one or more positioning measurements of the downlink signal transmitted by the TRP.

6. The method of claim 5, further comprising:
reporting, to the server, the hypothesis quality metrics for each TRP of the one or more TRPs; or
reporting, to the server, for each TRP of the one or more TRPs, based on the hypothesis quality metrics, an indication of which hypothesis of the one or more hypotheses provided better measurement performance for the one or more positioning measurements of the downlink signal transmitted by the TRP than remaining hypotheses of the one or more hypotheses.

7. The method of claim 5, wherein each hypothesis quality metric is based on a number of outlier measurements, inlier measurements, or both outlier measurements and inlier measurements resulting from a respective hypothesis of the one or more hypotheses.

8. The method of claim 1, further comprising:
calculating a position estimate for the UE based on the one or more positioning measurements and locations of the one or more TRPs.

9. The method of claim 1, wherein obtaining the one or more positioning measurements of the downlink signal comprises:
applying, for each TRP of the one or more TRPs, all of the one or more hypotheses to the downlink signal transmitted by the TRP; or
applying, for each TRP of the one or more TRPs, one of the one or more hypotheses to the downlink signal transmitted by the TRP.

10. The method of claim 1, wherein the time window comprises one or more bursts of one or more slots of the downlink signal.

11. The method of claim 1, wherein the downlink signal comprises a tracking reference signal (TRS), a positioning reference signal (PRS), or a channel state information reference signal (CSI-RS).

12. The method of claim 1, wherein the one or more positioning measurements comprise:
one or more downlink time of arrival (DL-TOA) measurements,
one or more reference signal time difference (RSTD) measurements,
one or more reference signal received power (RSRP) measurements,
one or more path RSRPs measurements,
one or more reception-to-transmission (Rx-Tx) time difference measurements,
one or more Doppler measurements, or
any combination thereof.

13. The method of claim 1, wherein the server comprises a connected intelligent edge (CIE) server or an over-the-top (OTT) server.

14. A method of communication performed by a server, comprising:
receiving, from a first user equipment (UE), identifiers of one or more transmission-reception points (TRPs) observed by the first UE; and
transmitting, to the first UE, a request to obtain one or more positioning measurements according to one or more hypotheses for measuring a downlink signal transmitted by the one or more TRPs, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal.

15. The method of claim 14, further comprising:
receiving, from the first UE, the one or more positioning measurements of the downlink signal for each of the one or more TRPs, the one or more positioning measurements obtained using the one or more hypotheses; and
determining, for each TRP of the one or more TRPs, which hypothesis of the one or more hypotheses provided better measurement performance for the one or more positioning measurements of the downlink signal transmitted by the TRP than remaining hypotheses of the one or more hypotheses.

16. The method of claim 15, further comprising:
transmitting, to a second UE, for each TRP of the one or more TRPs, an indication to use the hypothesis of the one or more hypotheses that provided the better measurement performance for the TRP than remaining hypotheses of the one or more hypotheses to obtain positioning measurements of the downlink signal transmitted by the TRP.

17. The method of claim 15, wherein:
the one or more TRPs comprise a first set of TRPs of a first network operator and a second set of TRPs of a second network operator,
a first hypothesis of the one or more hypotheses is determined to provide better measurement performance for the one or more positioning measurements of the downlink signal transmitted by the first set of TRPs than remaining hypotheses of the one or more hypotheses, and
a second hypothesis of the one or more hypotheses is determined to provide better measurement performance for the one or more positioning measurements of the downlink signal transmitted by the second set of TRPs than remaining hypotheses of the one or more hypotheses.

18. The method of claim 17, further comprising:
transmitting, to a second UE, a first indication to use the first hypothesis to obtain positioning measurements of the downlink signal transmitted by the first set of TRPs; and
transmitting, to the second UE, a second indication to use the second hypothesis to obtain the positioning measurements of the downlink signal transmitted by the second set of TRPs.

19-28. (canceled)

29. A user equipment (UE), comprising:
a memory;
at least one transceiver; and
at least one processor communicatively coupled to the memory and the at least one transceiver, the at least one processor configured to:
receive, via the at least one transceiver, from a server, a request to obtain one or more positioning measurements according to one or more hypotheses for measuring a downlink signal transmitted by one or more transmission-reception points (TRPs), wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal; and
obtain the one or more positioning measurements of the downlink signal for each of the one or more TRPs using the one or more hypotheses.

30. A server, comprising:
a memory;
at least one transceiver; and
at least one processor communicatively coupled to the memory and the at least one transceiver, the at least one processor configured to:
receive, via the at least one transceiver, from a first user equipment (UE), identifiers of one or more transmission-reception points (TRPs) observed by the first UE; and
transmit, via the at least one transceiver, to the first UE, a request to obtain one or more positioning measurements according to one or more hypotheses for measuring a downlink signal transmitted by the one or more TRPs, wherein each of the one or more hypotheses indicates a type of integration of the downlink signal, a time window during which to perform integration of the downlink signal, or both, and wherein the type of integration of the downlink signal is one of coherent, non-coherent, or both coherent and non-coherent integration of the downlink signal.
